(19) United States
(12) Patent Application Publication
(10) Pub. No.: US 2008/0270382 A1
(43) Pub. Date: Oct. 30, 2008

(54) System and Method of Personalizing Information Object Searches

(75) Inventors: Dan Thomsen, Hellerup (DK); Klaus Bjorn Jensen, Vanlose (DK)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: INTERSE A/S, Copenhagen K (DK)

(21) Appl. No.: 11/935,594

(22) Filed: Nov. 6, 2007

Related U.S. Application Data
(60) Provisional application No. 60/913,567, filed on Apr. 24, 2007.

(51) Int. Cl. G06F 17/30

(52) U.S. Cl. 707/5; 707/E17.001

(57) ABSTRACT

Described are a system and method of performing an electronic search for information objects in data stores. A user submitting a text string is identified. A metadata model comprises interconnected nodes. At least one node corresponds to a metadata instance. A catalog of catalog items is provided. Each catalog item is linked to a metadata instance in the metadata model and uniquely associated with an information object. A user-access right is assigned to each metadata instance. The catalog is searched to find catalog items linked to a metadata instance satisfying the user-access right and criteria associated with the submitted text string. Links to metadata instances are extracted in real time from each catalog item found in the search of the catalog. Each metadata instance corresponding to an extracted link is displayed, if permitted for the identified user by the user-access right assigned to that metadata instance.

### RELATED APPLICATIONS

This utility application claims the benefit of U.S. Provisional Patent Application No. 60/913,567, filed on Apr. 24, 2007, the entirety of which provisional application is incorporated by reference herein.

### FIELD OF THE INVENTION

The invention relates generally to information management. More specifically, the invention relates to systems and methods for increasing the findability of electronic content through consistent metadata generation for information objects maintained in heterogeneous data stores.

### BACKGROUND

Within most enterprises, the chances that a given search will quickly uncover relevant documents for review and retrieval are typically not promising. The importance of being able to find relevant information quickly is widely appreciated, and many efforts are underway to improve search performance. In an effort to improve search performance, some document management systems associate searchable metadata (i.e., information or data about other data) with stored documents. Examples of metadata that can be associated with a document include its type, its author, its title, keywords, creation date, and modification date.

Often, a document management system places the responsibility for manually associating metadata with a document on the document author. However, many document authors do not properly tag (i.e., classify) their metadata, if they provide any metadata at all. In addition, in large enterprises where there are hundreds or thousands of document authors, there is considerable inconsistency in the classifying of the metadata. In general, the metadata they generate are essentially unmanageable.

Moreover, the metadata of one document management system is typically inconsistent with the metadata of other document management systems. For example, what one document management system may refer to as a document's author another document management system may call the document's creator. Thus, a given search is typically ineffectual across the heterogeneous systems.

Further, some systems, such as a network file system (NFS), do not even have metadata, and searching is limited to text searches of the document name and contents. For some types of files, such as digital recordings and images, even text searches are of little use. Beset by so many shortcomings, conventional searching leaves much room for improvement.

### SUMMARY

In one aspect, the invention features a method of performing an electronic search for information objects stored in a plurality of data stores. A user submitting a text string is identified. A metadata model comprising a plurality of interconnected nodes is provided. At least one of the nodes corresponds to a metadata instance and at least one of the nodes corresponds to a metadata category. A catalog of catalog items is provided. Each catalog item being linked to one or more metadata instances in the metadata model and uniquely associated with an information object in one of the data stores. A user-access right is assigned to each metadata instance and to each metadata category. The catalog is searched to find one or more catalog items that are linked to one or more metadata instances in the metadata model that satisfy the user access right and criteria associated with the submitted text string. All links to metadata instances are extracted in real time from each of the catalog items found in the search of the catalog. Each metadata instance corresponding to one of the extracted links is displayed, if so permitted for the identified user by the user-access right assigned to that metadata instance.

In another aspect, the invention features a system for performing an electronic search for information objects stored in a plurality of data stores. A metadata model has a plurality of interconnected nodes. At least one of the nodes represents a metadata instance and at least one of the nodes represents a metadata category. A user-access right is assigned to each metadata instance and to each metadata category. A catalog includes catalog items, each catalog item being uniquely associated with an information object stored in one of the data stores. Each catalog item is also linked to one or more of the metadata instances of the metadata model. A search module identifies a user who submitted a text string, searches the catalog to find one or more catalog items that are linked to one or more metadata instances in the metadata model that satisfy the user access right and criteria associated with the submitted text string, and extracts in real time all links to metadata instances from each of the catalog items found in the search of the catalog. The system also includes means for displaying each metadata instance corresponding to one of the extracted links, if so permitted for the identified user by the user-access right assigned to that metadata instance.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a diagram of an embodiment of computing environment embodying an enterprise-wide information management system in accordance with the invention.

FIG. 2 is a diagrammatic representation of a user search being performed in a prior art system.

FIG. 3 is a diagrammatic representation of a user search performed in the information management system of the invention.

FIG. 4 is a diagram of an embodiment of system architecture of the information management system of the invention.

FIG. 5 is a diagram of an embodiment of a model builder module of the information management system.

FIG. 6 is a diagram of an embodiment of a metadata model, at a metadata category level, constructed automatically and/or manually through the model builder module from one or more external metadata sources and/or from user input.

FIG. 7 is a diagram representation of an exemplary construction of the metadata model from two external metadata sources.

FIG. 8 is a diagram of an embodiment of metadata model, at the metadata instance level, constructed by the model builder module from one or more external metadata sources.

FIG. 9 is a representation of an exemplary metadata model as a hierarchical tree structure.

FIG. 10 is an embodiment of a graphical window presented to a user who is viewing and administering the exemplary metadata model.

FIG. 11 is an embodiment of a graphical window displaying user-access rights for a particular metadata instance.

FIG. 12 is an embodiment of a graphical window displaying synonyms for the particular metadata instance.

FIG. 13 is an embodiment of a graphical window displaying relations for the particular metadata instance.

FIG. 14 is a flow diagram of an embodiment of a process for constructing the metadata model.

FIG. 15 is a diagrammatic representation of an embodiment of a catalog item (or library card).

FIG. 16 is a diagrammatic representation of a mapping of catalog items to metadata instances in the metadata model and to information objects maintained by heterogeneous data stores.

FIG. 17 is a flow chart of an embodiment of a process for generating a catalog item that is uniquely associated with an information object managed by a data store.

FIG. 18 is a flow chart of an embodiment of a process for classifying (or tagging) an information object based on relations between metadata instances in the metadata model.

FIG. 19 is a diagram of an example of a hierarchical file structure.

FIG. 20 is a flow chart of embodiments of processes for classifying a folder and for classifying an information object based on the folder location of the information object.

FIG. 21A is a diagram of an embodiment of a graphical user interface presented to a user for performing a search in accordance with the invention.

FIG. 21B is a diagram of a second embodiment of a graphical user interface presented to a user for performing a search in accordance with the invention.

FIG. 21C is a diagram of the second embodiment of a graphical user interface presented to the user after the search is complete.

FIG. 22 is a diagram of an embodiment of a filtered search results window displayed to a user after a search.

FIG. 23 is a flow chart of an embodiment of a process of searching for information objects managed by heterogeneous data stores in accordance with the invention.

### DETAILED DESCRIPTION

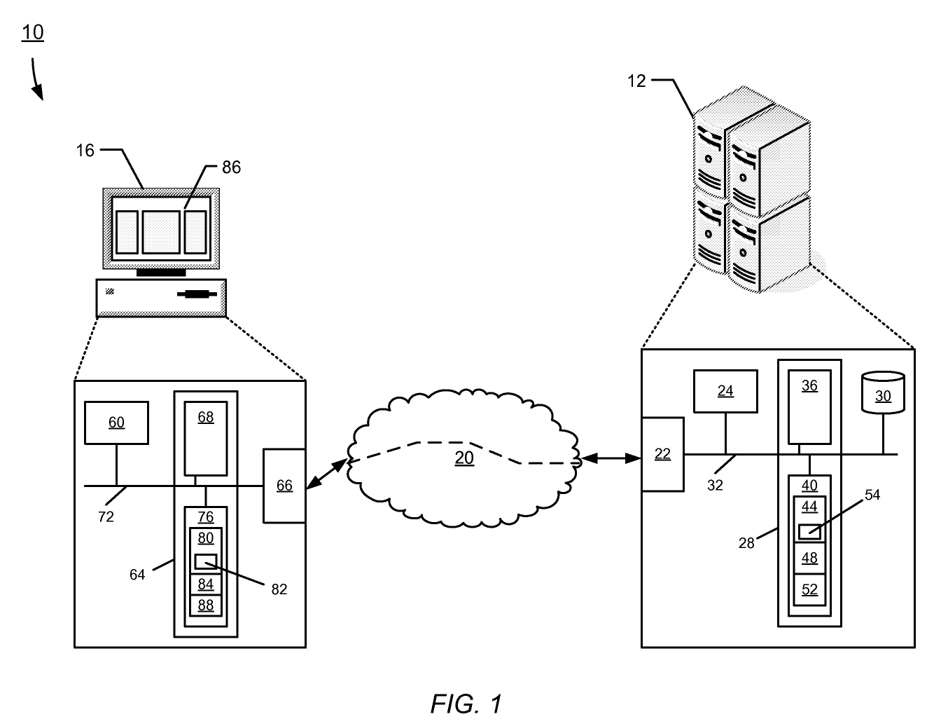

FIG. 1 shows an embodiment of a computing environment 10 in which the invention may be practiced. The computing environment 10 includes a server system 12 in communication with a client system 16 over a network 20. Embodiments of the network 20 include, but are not limited to, a local-area network (LAN), a metro-area network (MAN), and a wide-area network (WAN), such as the Internet or World Wide Web, or any combination thereof. The client system 16 can connect to the server system 12 over the network 20 through one of a variety of connections, for example, standard telephone lines, digital subscriber line (DSL), asynchronous DSL, LAN or WAN links (e.g., T1, T3), broadband connections (Frame Relay, ATM), and wireless connections (e.g., 802.11(a), 802.11(b), 802.11(g)).

The server system 12 represents an enterprise-wide system of servers that may be geographically collocated or distributed throughout an enterprise (i.e., a business organization). Exemplary servers supported by the server system 12 include, but are not limited to, an email server, an instant messaging server, a Web server, a file server, an application server, a document management server, and an active directory (AD) server. Each of the servers includes program code (software) for performing a particular service and is in communication with persistent storage, referred to herein as a data store or a repository, for storing electronic information objects related to those services, such as files, documents, web pages, images, and email messages. For example, a document management server includes program code for providing document management functionality and for accessing persistent storage within which reside documents managed by the document management server. As another example, an e-mail server includes program code for supporting email communication among client users and for accessing persistent storage that stores the email messages.

The server system 12 includes a network interface 22 (local and/or wide-area) for communicating over the network 20. A processor 24 is in communication with system memory 28 and a data store 30 over a signal bus 32. The data store 30 maintains an index constructed and used for searching managed information objects (e.g., documents, files, email messages) in accordance with the invention, as described in more detail below.

The signal bus 32 connects the processor 24 to various other components (not shown) of the server system 12 including, for example, a user-input interface, a memory interface, a peripheral interface, and a video interface. Exemplary implementations of the signal bus 32 include, but are not limited to, a Peripheral Component Interconnect (PCI) bus, a PCI Express bus, an Industry Standard Architecture (ISA) bus, an Enhanced Industry Standard Architecture (EISA) bus, and a Video Electronics Standards Association (VESA) bus. Although shown as a single bus, the signal bus 32 can be comprised of multiple busses of different types, interconnected by bridging devices, such as a Northbridge and a Southbridge.

The system memory 28 includes non-volatile computer storage media, such as read-only memory (ROM) 36, and volatile computer storage media, such as random-access memory (RAM) 40. Typically stored in the ROM 36 is a basic input/output system (BIOS), which contains program code for controlling basic operations of the server system 12 including start-up of the computing device and initialization of hardware. Stored within the RAM 40 are program code and data. Program code includes, but is not limited to, application programs 44, program modules 48 (e.g., browser plug-ins), and an operating system 52 (e.g., Windows 95, Windows 98, Windows NT 4.0, Windows XP, Windows 2000, Linux, and Macintosh).

The application programs 44 include an information management server 54 for increasing the findability of electronic content in accordance with the invention. In brief overview, the information management server 54 includes software for constructing and administering the index maintained in the data store 30.

The client system 16 is a representative example of one of the many independently operated client systems that may establish a connection with the server system 12 in order to manage information in the data store 30 and perform searches in accordance with the invention. The client system 16 includes a processor 60 in communication with system memory 64 and a network interface 66 over a signal bus 72. In addition, the client system 16 has a display screen 86. The display screen 86 connects to the signal bus 72 through a video interface (not shown). A user-input interface (not shown) coupled to the signal bus 72 is in communication with one or more user-input devices, e.g., a keyboard, a mouse, trackball, touch-pad, touch-screen, microphone, joystick, over a wire or wireless link, by which devices a user can enter information and commands into the client system 16.

Exemplary implementations of the client system 16 include, but are not limited to, personal computers (PC), Macintosh computers, workstations, laptop computers, terminals, kiosks, hand-held devices, such as a personal digital assistant (PDA), mobile or cellular phones, navigation and global positioning systems, and any other network-enabled computing device with a display screen, a processor for running application programs, memory, and one or more input devices (e.g., keyboard, touch-screen, mouse, etc).

The system memory 64 includes non-volatile computer storage media, such as read-only memory (ROM) 68, and volatile computer storage media, such as random-access memory (RAM) 76. The ROM 68 stores a basic input/output system (BIOS), for controlling basic operations of the client system 16, including start-up of the computing device and initialization of hardware.

The RAM 76 stores program code (e.g., proprietary and commercially available application programs 80) and data. The application programs 80 include, but are not limited to, an email client program (e.g., Microsoft Exchange), an instant messaging program, browser software (e.g., Microsoft INTERNET EXPLORER®, Mozilla FIREFOX®, NETSCAPE®, and SAFARI®), and office applications, such as spreadsheet software (e.g., Microsoft EXCEL™), word processing software (e.g., Microsoft WORD™), and slide presentation software (e.g., Microsoft POWERPOINT™).

In one embodiment, the application programs 80 also include a client-side information management application 82, which presents a user interface through which the client system user can administer the index, classify metadata for information objects, and initiate searches, as described in more detail below. In the performance of such functionality, the client-side information management application 82 communicates with the server-side information management application 54 over the network 20.

In other embodiments, the information management application 82 can reside at the server system 12 (e.g., as in a thin-client client-server network), or the server-side information management application 54 can incorporate the described functionality of the client-side information management application 82. In such embodiments, the client system 16 connects to the server system 12 and remotely executes the client-side information management application 82 and/or the server-side information management application 54 at the server system 12.

Aspects of the described functionality of the client-side information management application 82 can also be integrated, as a plug-in 84, into one or more commercially available third-party application programs 80, e.g. Microsoft WORD™. Such integration typically requires modification of the third party-application program to enable manual or automatic execution of the client-side functions.

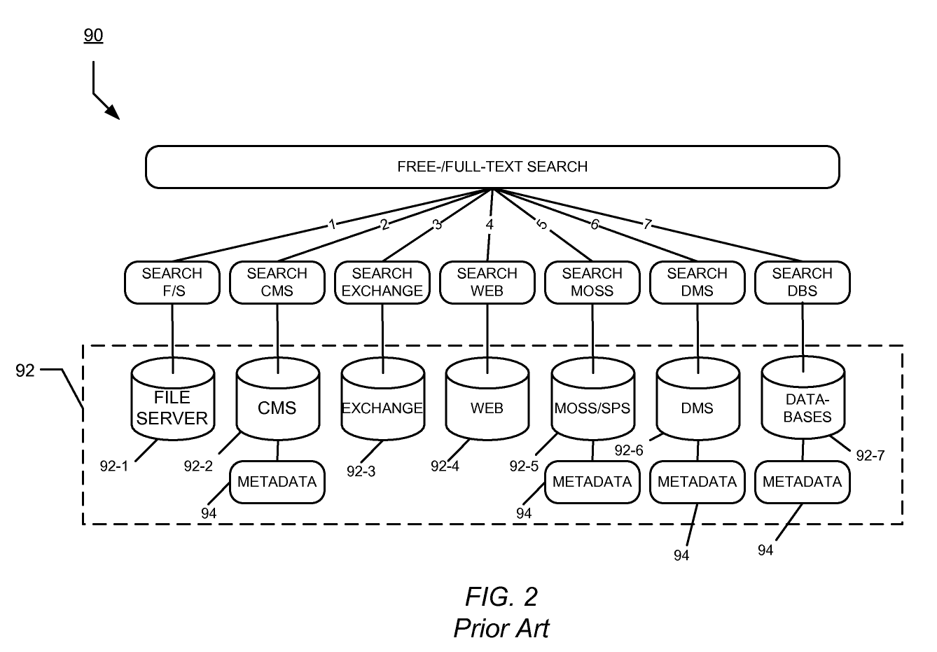

Advantages of the present invention are readily apparent when compared to a typical prior art implementation. FIG. 2 diagrammatically illustrates a searching process in a prior art system 90. As shown, the system 90 includes a plurality of heterogeneous data stores 92 that store various types of information objects (e.g., documents, files, email messages, web pages, etc.). Examples of such data stores 92 include a file server 92-1 (e.g., NTFS), a Content Management System (CMS) 92-2, an email system (e.g., Microsoft EXCHANGE™) 92-3, a web store 92-4, a SharePoint server (SPS) system 92-5, a document management system (DMS) 92-6 (e.g., Interwoven® Imanage), and a database management system (DBMS) 92-7 (e.g., Oracle®).

Some of the data stores 92, such as the CMS 92-2, the SPS system 92-5, the DMS 92-6, and the DBMS 92-7, associate metadata 94 with the objects stored in that particular data store. Such metadata, referred to as native metadata, typically has a format for storage and retrieval that is particular to a given data store. Usually, such formats differ from one type of data store to the next. In addition, metadata classifications are often inconsistently applied from one data store to the next (e.g., one data store may refer to the originator of a document as its creator, another as its author, and still another as its originator).

For the particular system 90, a client user wanting to perform a thorough search spanning all data stores 92 for information objects related to a particular subject would need to search each of the various data stores individually (here, represented as seven distinctly enumerated searches). To execute the search, the user may need to employ the user interface particular to each data store and to know the particular metadata classifications by which that data store classifies information objects.

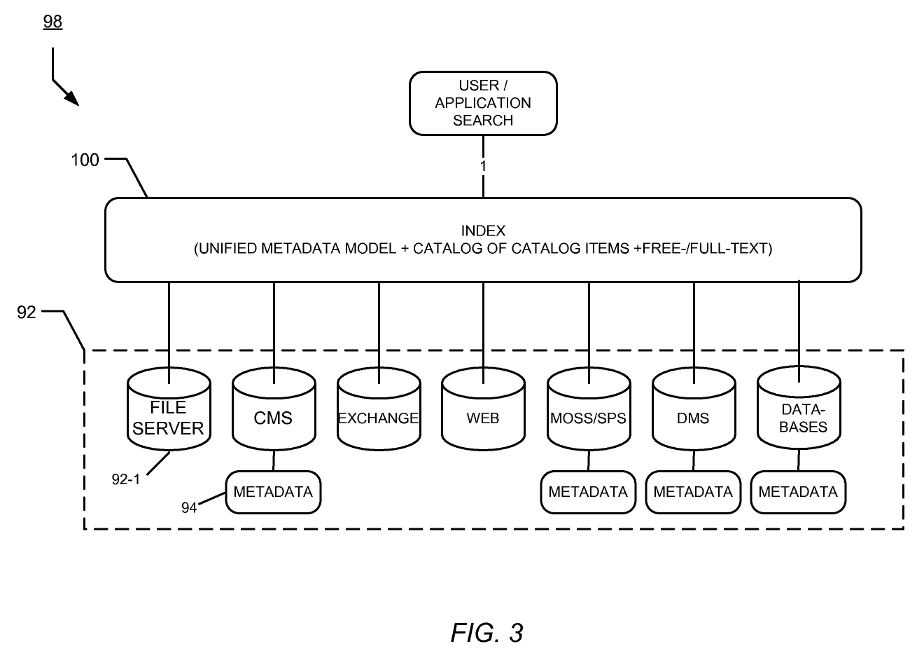

FIG. 3 conceptually illustrates how an information management system 98, constructed in accordance with the invention, can simplify the searching process from the user's perspective, and enhance the quality of the search results. Instead of having to search each of the data stores 92 individually, as described in FIG. 2, a user of the information management system 98 performs a single search of an index 100. The index 100 comprises a unified metadata model, a catalog of catalog items, and free/full text of various information objects in the data stores 92, and provides consistent classification of information objects across all data stores 92, as described in more detail below. In effect, the index 100 serves like a proxy for the various data stores 92 against which the client user can submit a single search through a single user interface (e.g., from within an application program). In effect, the single search of the index 100 operates like a concurrent search of all of the various data stores 92, and the information objects presented to the user as search results can reside in any one or more, or in all of the various data stores 92.

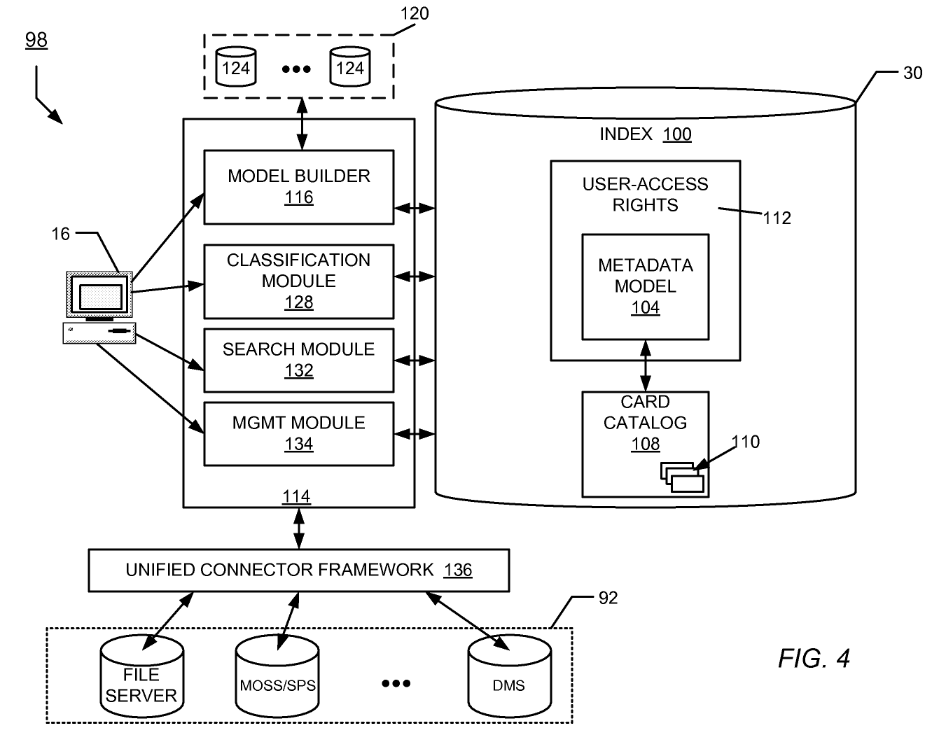

FIG. 4 shows an embodiment of system architecture for the information management system 98 of the invention. The system architecture includes the data store 30 (FIG. 1) maintaining the index 100 (FIG. 3). The index 100 comprises a metadata model 104 and a card catalog 108 of catalog items 110 (also referred to as library cards or cards). Unique one-to-one correspondences exist between catalog items 110 in the catalog 108 and information objects maintained by the various data stores 92. Some catalog items 110 have a unique one-to-one correspondence with a location of an information object, such as folders, document libraries, web sites, web portals. The index 100 (i.e., the metadata model 104 and card catalog 108) is external to the various data stores 92 and application programs that access information objects in the data stores 92.

In general, the metadata model 104 is part of a centralized mechanism for providing consistent enterprise-wide classification of information objects. Classification, as used herein, refers to a process of associating metadata (including metadata categories and metadata instances) with information objects. The metadata model 104 provides a “pool” of metadata from which metadata can be selected for association with information objects. This metadata pool derives from one or more enterprise database systems 124, as described in more detail below, or can be generated manually. Restricting classification to the particular metadata categories and metadata instances in the metadata model 104 achieves consistent classification of information objects across the various data stores 92, irrespective of the particular types of these data stores 92. User-access rights 112 can be established for each of the various metadata categories and metadata instances in the metadata model 104.

In communication with the index 100 is an information management application 114 (representing together the client-side 82 and server-side 54 applications described in FIG. 1). The information management application 114 includes a model builder module 116, a classification module 128, a search module 132, and a management module 134. In one embodiment, the search module 132 executes at the server system 12; a client-side component of the model builder module 116 executes at the client system and a server-side component of the model builder module 116 executes at the server system 12; and a client-side component of the classification module 128, embedded within a third-party application, executes at the client system 16, and a server-side component of the classification module 128 used for automatic classification executes at the server system 12.

The model builder module 116 (generally, metadata model builder) constructs the metadata model 104 from an enterprise information management system 120 that includes one or more enterprise-wide database systems 124 used by the enterprise to manage its business-related operations. The model builder module 116 can construct the metadata model 104 manually (i.e., through user input) or automatically, based on one or more of the enterprise database systems 124, on other information sources (e.g., input from the user), or on combinations thereof.

Examples of such enterprise database systems 124 include, but are not limited to, an Enterprise Resource Planning (ERP) software system, a Customer Relationship Management (CRM) system, and an Active Directory (AD) system. In general, ERP is a software system that integrates departments and functions across an enterprise into a single database system, enabling the various departments to share information and communicate with each other. CRM is a software solution that helps an enterprise manage its customer relationships. An Active Directory (AD) system includes information about users, groups, organizational units and other kinds of management domains and administrative information about a network to represent a complete digital model of the network. Each of the enterprise database system 124 defines data structures and relationships among data structures adapted for its particular purpose.

In general, the classification module 128 (or classifier) identifies metadata within the metadata model 104 that may be used to classify (i.e., tag) a given information object. The identified metadata are recorded on the particular catalog item 110 uniquely associated with the information object being classified. Classification of an information object with metadata from the metadata model 104 can occur manually (i.e., at the client system 16 through an interactive user selection) or automatically at the server system 12.

The process of classifying an information object occurs independently of the data store 92 that maintains the information object; that is, the classification module 128 is not tied to any data store 92. The same classification module 128 can work with a variety of third-party applications, such as Microsoft Word, Microsoft Excel, Microsoft PowerPoint, Microsoft Outlook, Adobe Reader, Windows file explorer, and Internet Explorer, irrespective of where the information objects are actually stored.

In brief overview, the search module 132 provides an interactive web-based search interface to the client user. In response to a text string supplied by the user, the search module 132 searches the index 100, as described below, to identify information objects that may satisfy the user's search. Also described below, the search module 132 enables the user to refine (or filter) the search results.

The management module 134 provides an interactive interface by which personnel can administrate the information management system 98 (e.g., determine which enterprise database systems and data stores to scan for generating and updating the metadata model and catalog items, how often to perform such scans, etc.).

The information management application 114 is also in communication with a unified connector framework 136. The connector framework 136 includes logic (hardware, software, or a combination thereof) by which information management application 114 can communicate with each of the data stores 92 through interfaces (e.g., APIs, SQL commands) provided by those data stores 92. Such interfaces are specific to the type of data store 92. Through the connector framework 136, the information management application 114 is able to access each of the information objects maintained by the data stores 92 and acquire various information about those information objects, for example, their content, properties, native metadata, security settings, storage (pathname) locations, authors, and dates of creation, modification, and printing.

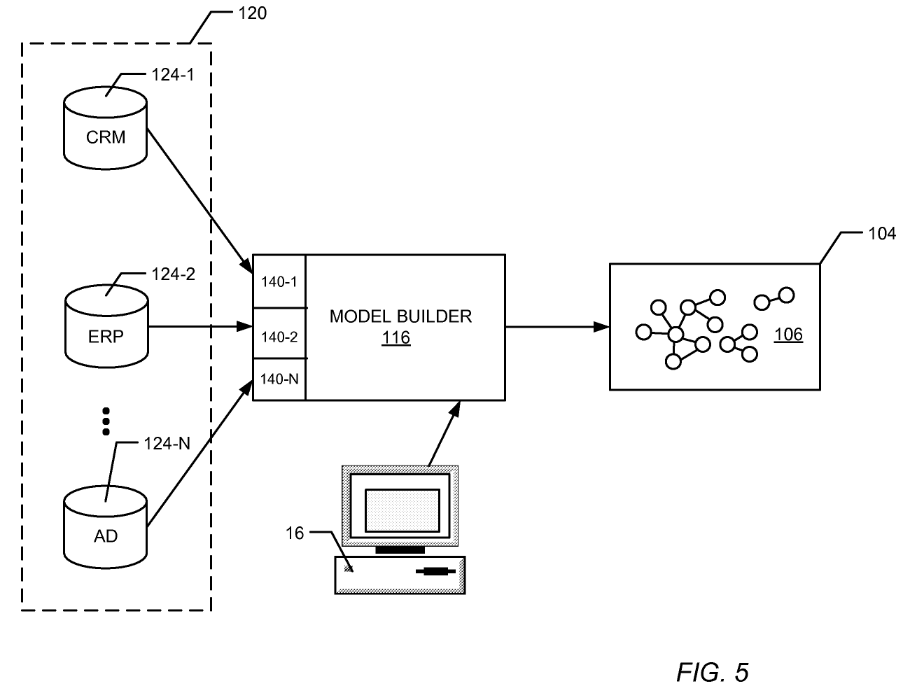

FIG. 5 shows a block diagram illustrating generally the operation of the model builder module 116 in the construction of the metadata model 104. The model builder module 116 includes connector logic 140-1, 140-2, 140-n (generally, 140) to communicate with the one or more of the various enterprise database systems 124 (here, e.g., ERP, CRM, and AD) in order to extract and analyze the business data structures and relationships among the data structures employed by those systems 124. The connector logic 140 is specific to the particular type of enterprise database system 124. An enterprise may have fewer, more, and different types of enterprise database systems than what is shown in FIG. 5.

From one or from a combination of these enterprise database systems 124, or from manual user input, categories and relationships among the categories can be reflected in the model builder module 116. These categories, referred to herein as metadata categories, and their relationships provide a “skeletal” or “template” structure for metadata instances, also derived from the enterprise database systems 124.

Based on these metadata categories and relationships, the model builder module 116 produces an n-dimensional metadata model 104 represented here, for illustration's sake, as an n-dimensional graph 106. Other data structures can be used to represent the organization of the metadata categories and metadata instances of the metadata model 104 (e.g., a hierarchical tree) without departing from the principles of the invention.

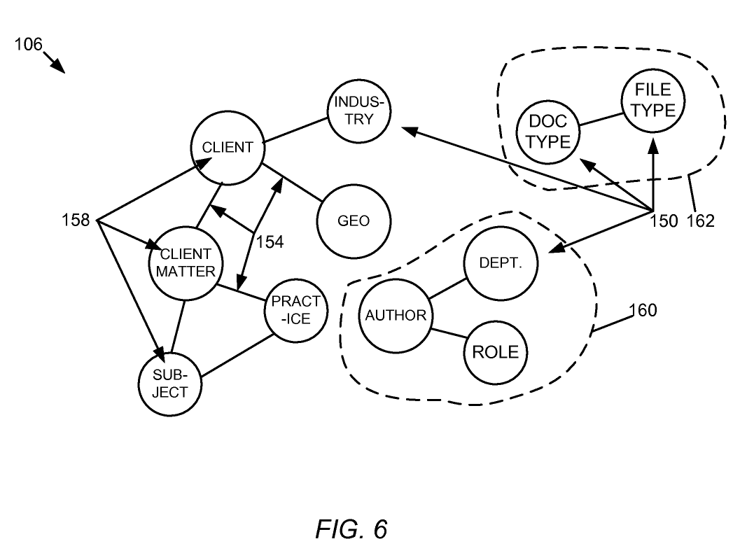

FIG. 6 shows an example of an example of n-dimensional graph 106 representation generated from one or more of the enterprise database systems 124. The graph 106 includes a plurality of nodes 150 interconnected by links 154. Each node 150 represents a metadata category 158, and each link 154 represents a relationship between metadata categories 158. In this example, the metadata categories (i.e., nodes) include client, client matter, practice, subject, geography, and industry. As indicated by the various links 154, the category named client has a relationship with each of the client matter, geography, and industry categories. In addition, the category named client matter has a relationship with the metadata category called subject and with the metadata category called practice. Another section 160 of the graph 106 includes an author metadata category, which is related to an office location category and a role category. This section 160 illustrates that sections of the graph 106 can be disjoint. Another disjoint section 162 includes a metadata category, called doc type, which is related to another metadata category, called file type.

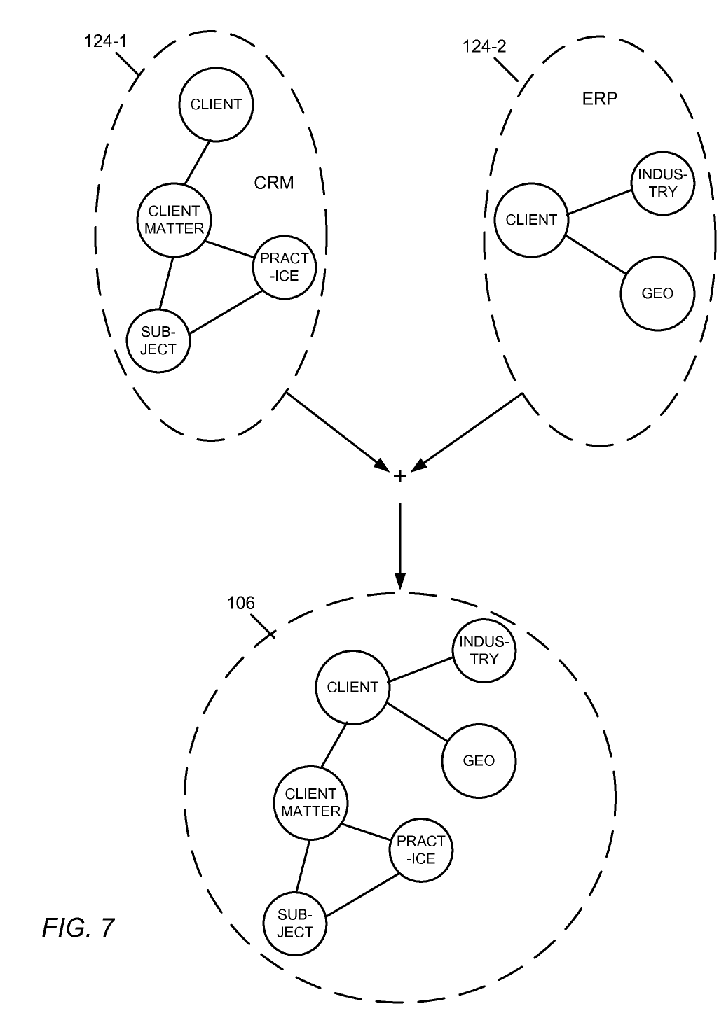

FIG. 7 shows an oversimplified example in which the graph 106 is constructed from multiple enterprise database systems 124 (here, for illustration purposes, a CRM database and an ERP database). From the CRM system 124-1, the model builder module 116 extracts a client category and identifies relationships with the client matter category and with the geography category. Also from the CRM system 124-1, the model builder module 116 determines that the client matter category has a relationship with the subject category and with the client practice category. From the ERP database 124-2, the model builder module 116 determines that clients are related to geography and industry. Using the common category of client, the model builder module 116 can construct the graph 106, which is a composite of the categories and relationships of both enterprise database systems 124-1, 124-2.

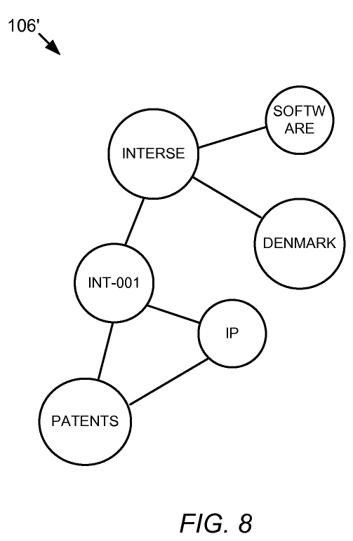

The graph 106 representing the interconnectivity among the metadata categories operates as a template for defining instances of metadata acquired from the enterprise database system 124. FIG. 8 shows one example of a metadata instance, extracted from the enterprise database systems 124 or manually inserted by user input, and defined according to the exemplary graph 106 of FIG. 6.

As a representative example of a metadata instance, the metadata category called client has an instance called “Interse”. According to the graph 106, the client category has relationships with three other metadata categories called client matter, geography, and industry. Specific metadata instances of the metadata categories of client matter, geography, and industry are identified as “INT-001”, Denmark, and software, respectively. The specific metadata instances relevant to the client Interse are acquired from the enterprise database system(s) 124 from which the graph 106 is derived. In addition, the client matter category has relationships with two other metadata categories called subject and practice. These specific instances of the metadata categories, as they relate to the client Interse, are labeled Patents and IP, respectively.

The resulting graph 106′ represents a metadata instance comprised of other metadata instances. The metadata model 104 is populated with hundreds, thousands, tens of thousands of such metadata instances corresponding to data taken from the one or more of the enterprise database systems 124 (or manually entered), and structured according to the template defined by the metadata category graph 106.

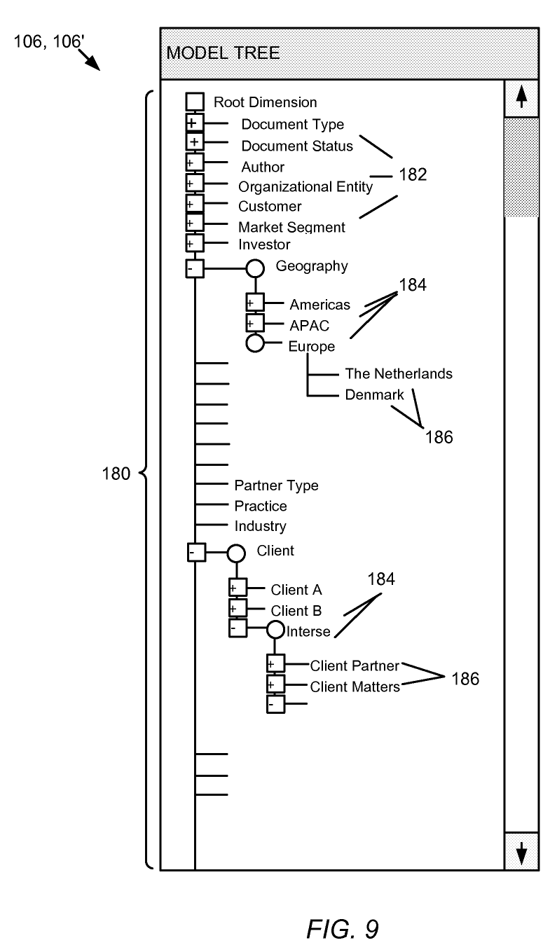

FIG. 9 shows an embodiment of a graphical user interface for viewing the metadata model 104. The metadata categories and metadata instances are arranged here in a hierarchical tree structure 180. This tree structure encompasses the metadata category graph 106 and each metadata instance graph 106′ generated from the enterprise database system(s) 124. Excepting the root node (here, labeled “Root Dimension”), the metadata categories 182 appear at the highest level of the tree structure 180. Examples of metadata categories appearing in the tree structure 180 are document type, author, customer, geography, industry, and client.

At the next level below the level of the metadata categories 182 are metadata instances 184. Each metadata instance 184 at the next level branches from a metadata category 182. For example, metadata instances labeled Americas, APAC, and Europe fall under the metadata category called Geography. Other metadata instances 186 can branch from a metadata instance 184 at a higher level. Metadata instances labeled The Netherlands and Denmark are examples of such metadata instances. There is no limit to the number of metadata categories and levels of metadata instances within the tree structure 180.

Through the model builder module 116, a client user can define and establish the external metadata sources for the metadata categories and instances, such as the AD, ERP, etc. The client user can also define and manage the display terms (i.e., names) for each of the metadata categories and instances (e.g., Geography, The Netherlands) and the relationships among such metadata categories and instances. The model builder module 116 also provides an interface by which the client user can create, delete, drag and drop metadata categories and instances. Any changes to the metadata model 104 are effective immediately for search purposes, without having to re-index the information objects, as described in more detail below. The client user can also manage user-access rights assigned to each of the metadata categories and instances.

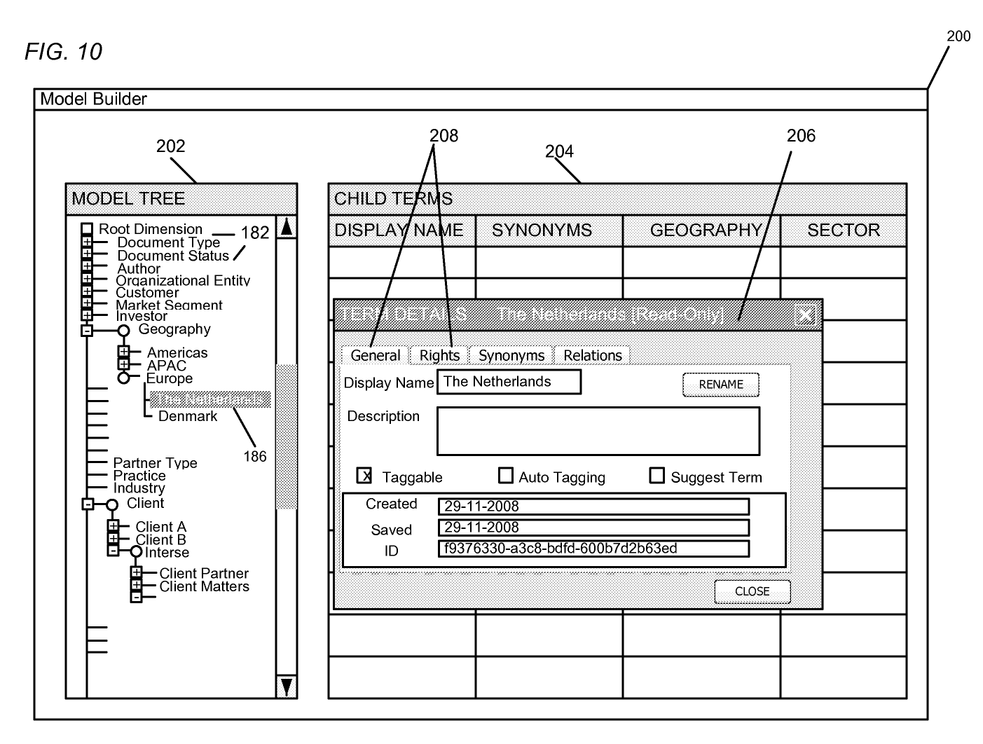

FIG. 10 shows an example of a graphical window 200 that the model builder module 116 may display to the client user in the course of viewing and administering the metadata model 104. The window 200 includes a left pane 202 in which appears the hierarchical tree structure described in FIG. 9. Within the left pane 202 appears the metadata instance 186 labeled “The Netherlands” in highlight, indicating that the client user is specifically viewing this particular metadata instance. The window 200 also has a right pane 204, which lists metadata instances that are children of the currently viewed metadata instance. None appears in this pane 204 because the “The Netherlands” instance has no children.

In response to user direction, a dialogue window 206 may appear within the window 200, providing additional details about the “The Netherlands” instance, here, being used a representative example of the other metadata instances. The dialogue window 206 includes a set of tabs 208 called: General, Rights, Synonyms, Relations, and Properties.

In FIG. 10, the details of the tab labeled General are illustrated. The General tab indicates that the display name of this metadata instance 186 is called “The Netherlands”. A user can rename the display name, which would change listed name of the metadata instance 186 as it appears in the tree structure. Options available for managing this metadata instance 186 include selecting taggable, auto tagging, and suggest term. A taggable (i.e., classifiable) term means that the term can be applied as metadata on information objects or locations (folders, document libraries, sites or areas). A suggested term means that the term will be suggested as an available tag/classification if the term or any synonyms of that term are part of the content in the information object from which the Tagging Client/Classification Module is opened. Auto tagging (i.e., auto classification) means that a term and its related metadata terms will automatically be applied to all files and possibly locations that contain the term, a synonym of the term or a language variation of the term. In addition, the metadata instance has an unchangeable identifier (ID), which uniquely identifies this metadata instance within the metadata model 104. Metadata categories 182 also have unique identifiers.

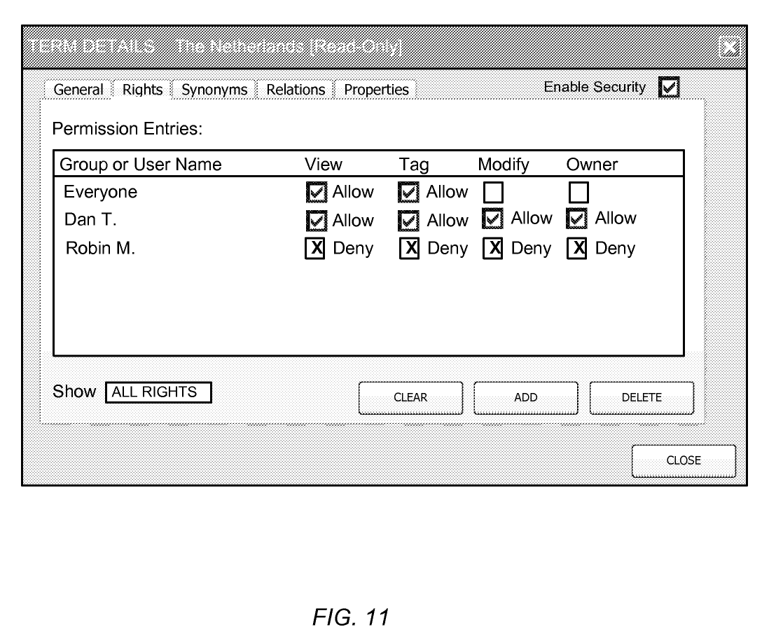

FIG. 11 shows exemplary details displayed in the Rights tab for the “The Netherlands” metadata instance. Assigned to each metadata category and metadata instance is a set of user-access rights. In this embodiment, the set of user-access rights includes a viewing right, a tagging right, a modifying right, and an owner right. These user-access rights may be granted to defined groups of users and to individuals. As described further below, the user-access rights enable personalization of search on metadata, personalized tagging (classification), and personalized metadata modeling.

Viewing rights assigned to a given metadata category or metadata instance determine whether that category or instance is displayed to the specified group or individual as part of a search result. Tagging rights assigned to a given metadata instance determine whether the metadata instance may be used to tag information objects by a specified group of users or by individual users. Referring to the “The Netherlands” metadata instance as an illustrative example, anyone belonging to the group called Everyone is granted viewing and tagging rights. The roles of viewing and tagging rights are described in more detail below.

The modifying and owner access rights involve management (i.e., administration) of the metadata model. The modifying right determines whether a member of a specified group or an individual user is permitted to modify details of a given metadata category or instance. The owner right controls who is permitted to delete a given metadata category or metadata instance.

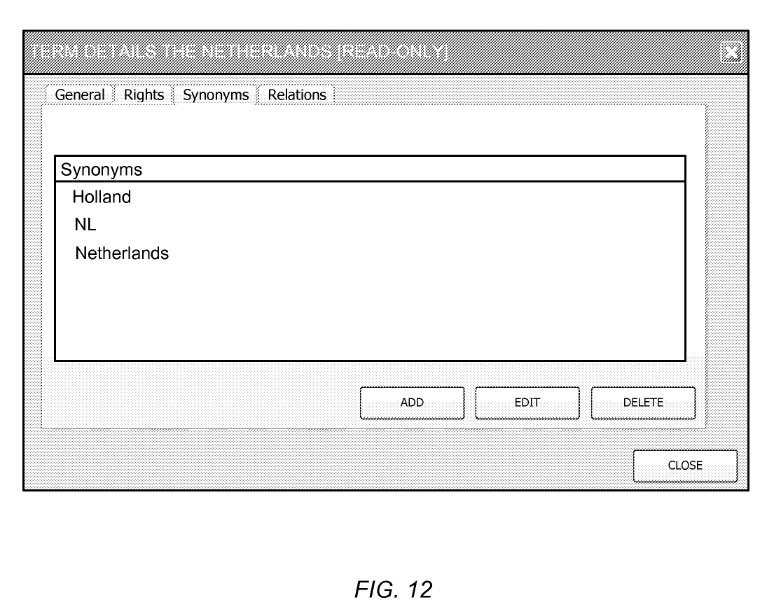

FIG. 12 shows exemplary details displayed in the Synonyms tab for the “The Netherlands” metadata instance. In general, each metadata instance can have zero, one, or more synonyms associated therewith. During a lookup of the metadata model 104, such synonyms provide an alternative mechanism by which a given metadata instance may be identified as relevant to a user search. In the present example, the “The Netherlands” metadata instance has three associated synonyms: Holland, NL, and Netherlands. A user specifying any of these three synonyms in a search would select the “The Netherlands” metadata instance during a lookup of the metadata model 104.

Although not shown, each metadata instance may also have another separate tab for specifying language variations associated with the metadata instance. For example, consider a metadata instance labeled United States; specified instances of language variations can include les Etats-Unis and los Estados Unidos.

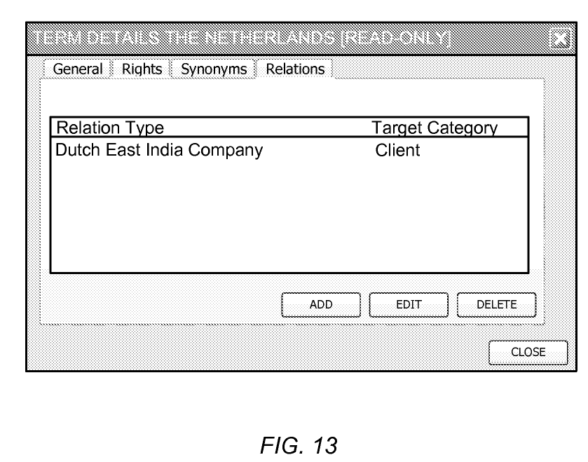

FIG. 13 shows exemplary details displayed in the Relations tab for the “The Netherlands” metadata instance. As described in FIG. 6 and in FIG. 8, each metadata category can be related to one or more other metadata categories. In addition, each metadata instance can likewise be related to other metadata instances that belong to same or other metadata categories. Metadata instances can also be children of parent metadata instances. For example, the “The Netherlands” metadata instance is a child of the Europe metadata instance (here, the parent). Europe and The Netherlands both are in the Geography metadata category. According to the graph 106 shown in FIG. 6, the Geography metadata category has a relationship with the Client metadata category. Accordingly, appearing within the Relations tab for the “The Netherlands” metadata instance are one or more specific metadata instances of clients (here, as an example, the Dutch East India Company).

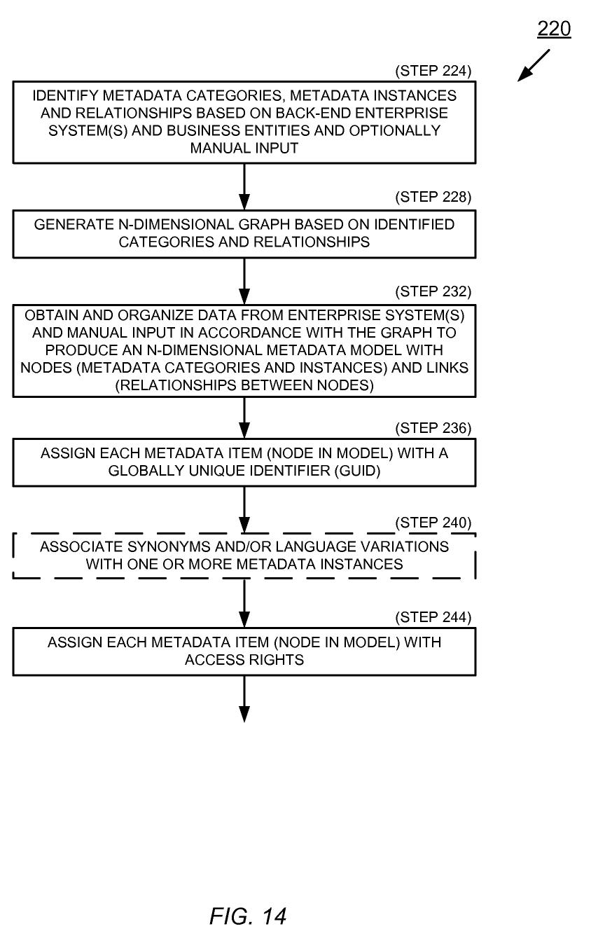

FIG. 14 shows an embodiment of a process 220 for building the metadata model 104. In the description of the process 220, reference is also made to FIG. 4. At step 224, the model builder module 116 extracts metadata categories, instances, and relationships based on one or more of the enterprise database systems 124 and business entities. Such information can also be generated manually through user input. The model builder module 116 can choose certain key categories, and combine categories and relationships taken from multiple enterprise database systems 124 (and, if any, user input). From the selected categories and relationships, the model builder module 116 generates (step 228) an n-dimensional graph representing a template data structure to be applied to the specific instances of data within the enterprise database systems.

At step 232, the model builder module 116 obtains and organizes data from the enterprise database system(s) 124 and from manual input, if any, in accordance with the graph to produce the n-dimensional metadata model 104, with some nodes representing metadata categories, other nodes representing metadata instances, and links representing relationships between metadata instances. Each node (i.e., metadata category and instance) is given (step 236) a unique identifier. Optionally, synonyms, language variations, or both are associated (step 240) with one or more of the metadata instances. At step 244, each node (i.e., metadata category and instance) is assigned a set of user-access rights.

### Catalog and Catalog Items

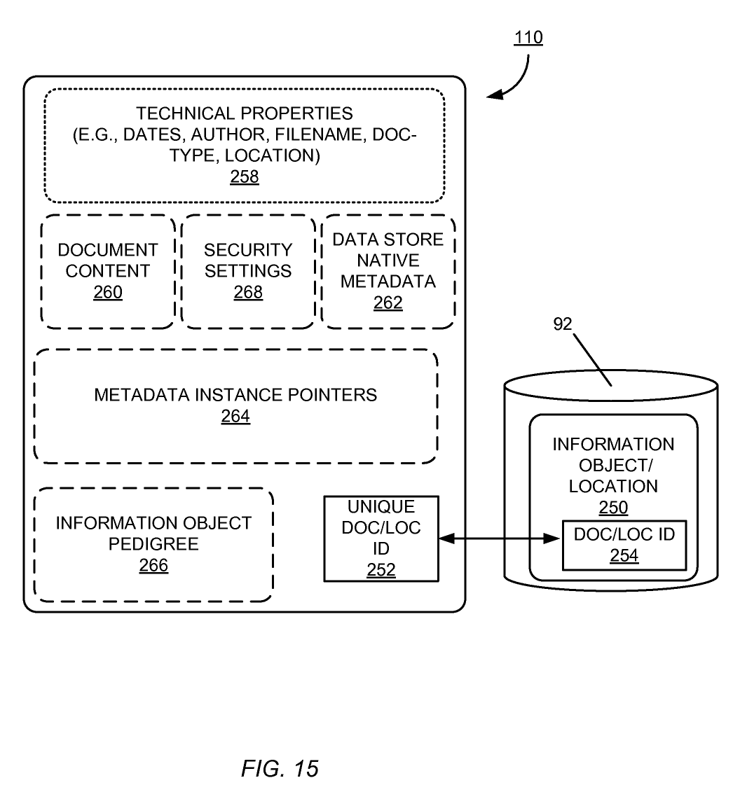

FIG. 15 shows an exemplary embodiment of a catalog item 110 (FIG. 4). As previously noted, each catalog item 110 is uniquely associated with an information object or object location stored in one of the data stores 92. To produce a unique association between a given catalog item 110 and an information object 250, the catalog item 110 has a globally unique document ID (DOC ID) 254 that matches the DOC ID 256 of the information object 250. (The DOC ID is referred to as a location ID (LOC ID) when the catalog item 110 is uniquely associated with a location). In addition to serving as a unique identifier by which an information object may be tracked, the DOC ID serves as an indicator that the information management system has already processed the information object (or location). In one embodiment, the particular data store 92 maintaining the information object 250 generates the DOC ID 256 for the information object 250, and the catalog item 110 adopts this DOC ID 254 as a pointer to the information object 250.

The catalog item 110 can also include one or more of the following types of information: information object properties 258, information object content (e.g., text) 260, data store-specific native metadata 262, pointers to metadata instances in the metadata model 264, information object pedigree 266, and security settings 268. The information object properties 258 (e.g., date created, date modified, author, filename, file type of information object, object storage pathname location) document content 260 are acquired from the information object 250. The document content 260 enables text-based searching, as described below. Some types of information objects, such as images and music files, do not have text that can be extracted from the body of such objects, and consequently, catalog items 110 associated with such information objects have no document content 260.

The native metadata 262 may be acquired from the data store 92 maintaining the information object 250. Many types of data stores 92 do not keep native metadata for the information objects. Accordingly, catalog items 110 associated with such information objects maintained by such data stores have no native metadata 262.

Metadata instance pointers 264 become part of the catalog item 110 as a result of automatic or manual classifying or tagging of the information object 250, as described further below. These metadata instance pointers 264 comprise globally unique IDs (GUIDs), each unique ID corresponding to the globally unique ID of one of the metadata instances in the metadata model. Some catalog items 110 may not be classified (tagged) with metadata, and thus do not have any metadata instance pointers.

The recording of metadata instance GUIDs on the catalog item 110, instead of the display names of the metadata instances, advantageously conceals the tagging from a person attempting to read the catalog item 110 to discern its contents. Additionally, the use of metadata instance GUIDs renders any changes to the details of a metadata instance transparent to the catalog items 110. For example, if a user renames the display name of a given metadata instance, modifications to the catalog items 110 to accommodate this change are unnecessary because the GUID of the given metadata instance, to which the catalog items point, does not change. This enables the information management system 98 to adapt rapidly to changes to metadata instances in the metadata model 104.

The information object pedigree 266 tracks the location and modification history of the information object using the DOC ID assigned to the information object. The security settings 268 determine which individual users and groups of users are able to access the information object. The catalog item acquires the security settings 268 from the particular data store managing the information object.

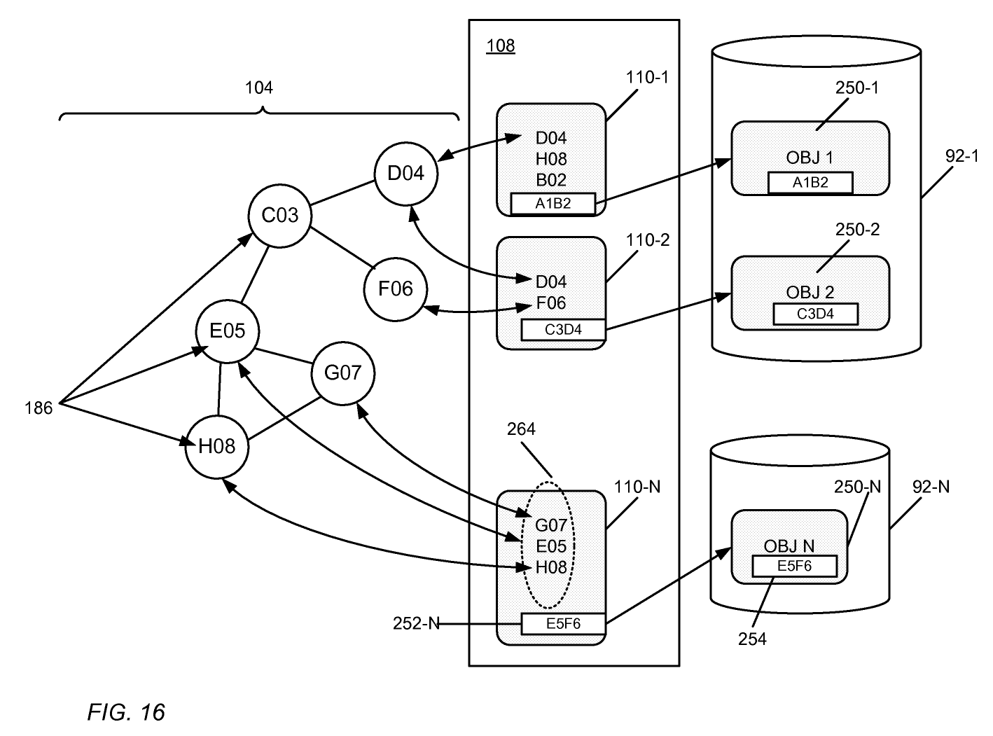

FIG. 16 shows an exemplary mapping of catalog items 110-1, 110-2, 110-n (generally, 110) to metadata instances 186 in the metadata model 104 and to information objects 250-1, 250-2, 250-n (generally, 250) managed by heterogeneous data stores 92-1, 92-n. The mapping between catalog items 110 and metadata instances 186 is based on the pointers 264 to the GUIDs of the metadata instances; the mapping between catalog items 110 and information objects 250 is based on DOC IDs 252 pointing to the DOC IDs 254 of the information objects 250.

Catalog item 110-N, as a representative example, includes metadata instance pointers 264 represented by three alphanumeric values: G07, E05, and H08. These alphanumeric values correspond to the GUIDs of particular metadata instances 186 in the metadata model 104. Catalog item 110-N also includes an object DOC ID 252-N that maps to the information object 250-N (OBJ N) maintained by the data store 92-N.

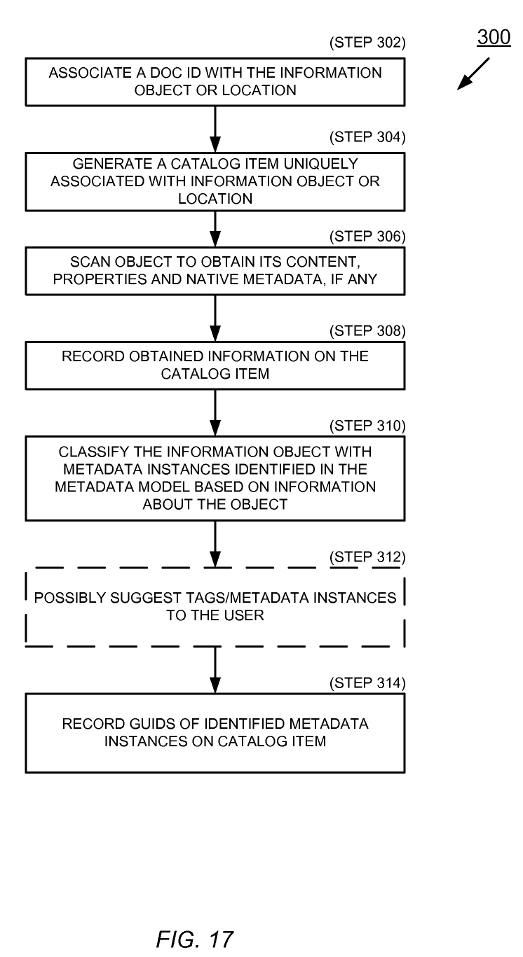

FIG. 17 shows an embodiment of a process 300 for generating a catalog item 110 for an information object 250. Although described herein with respect to an information object 250, the process 300 can also be performed for automatically generating a catalog item 110 for a location. The process 300 may run upon initial installation of the information management system 98 within the enterprise or upon the generation of a new information object. In the description of the process 300, reference is made also to FIG. 15.

At step 302, a DOC ID 254 is associated with the information object 250 (if not already assigned by the data store 92 managing the information object). If not previously assigned, the DOC ID 254 is recorded on the information object 250 or in a property field linked to the information object 250. The classification module 128 (FIG. 4) generates (step 304) a catalog item 110 uniquely associated with this information object 250 by recording a DOC ID 252 on the catalog item 110 matching the DOC ID 254 of the associated information object 250.

At step 306, the classification module 128 scans the information object 250 to acquire text from the contents of the object, properties, security settings, and native metadata of the information object 250, if any. The classification module 128 records (step 308) the acquired information on the catalog item 110.

Using the acquired text and other properties, e.g., the author, filename, and object location, the classification module classifies (step 310) the information object by identifying metadata instances in the metadata model that are relevant to the information object and may prove useful when searching for the information object. The association of synonyms and language variations with various metadata instances in the metadata model can increase the number of metadata instances identified. In one embodiment, shown in dashed lines, the classification module can also suggest (step 312) these metadata instances to the user, from which the user makes a selection. The classification module records (step 314) the GUIDs of the identified metadata instances on the catalog item. The recording of the metadata instance GUIDs on the catalog item can occur both automatically and manually (i.e., based on the user selection). The newly generated catalog item 110 is kept in the external catalog 108.

### Classification of Information Objects

Classification is a process of tagging information objects with metadata. The ability to classify information objects precisely improves the ability to find relevant information objects during a search. The classification module 128 performs tagging: for example, at step 310 of the above-described process 300, the classification module 128 looks through the metadata pool defined by the metadata model 104 to identify metadata instances with which to tag the information objects.

The information objects themselves are not tagged, rather the tagging occurs to the catalog items associated with the information objects. More specifically, tagging results in the recording of the unique identifiers of identified metadata instances in the metadata model on catalog items associated with the information objects. Tagging occurs upon initial installation of the information management system 98 (i.e., on information objects presently residing in various data stores when the information management system 98 is introduced to the enterprise) and upon subsequent generation of new information objects.

Tagging can occur automatically, semi-automatically, or manually. Automatic tagging occurs at the server-side. Semi-automatic and manual tagging occur at the client-side and involve user interaction. Semi-automatic tagging occurs when the user, executing a third-party application, acts to save an information object as a new object (i.e., a “Save As” operation), rather than as a modified existing object (i.e., a “Save”). The Save-As operation causes the classification module, integrated with the third-party application, to launch. Examples of third-party applications into which the classification module may be integrated include, but are not limited to, Microsoft Office, Microsoft File Explorer, Microsoft Internet Explorer, Microsoft Exchange Server, Microsoft SharePoint Portal, Windows Server, Microsoft Content Management Server, SQL, Interwoven, and Documentum.

The classification module identifies relevant metadata instances, as described below, and displays these metadata instances to the user as suggested tags for the information object. The user selects from among one or more of the suggested metadata instances. Automatic and semi-automatic tagging ensures consistent identification of tags for information objects. For manual tagging, the user can launch the classification module from within a third-party application and manually select metadata instances not suggested by the classification module.

Identifying metadata instances in the metadata model with which to tag information objects occurs automatically on various bases: (1) content of the information object, synonyms, and language variations; (2) relations; (3) a folder or site location of the information object as maintained by a data store; and (4) user-access rights.

### Content-Based Classification

In brief, content-based classification uses content acquired from the body of an information object to identify metadata instances in the metadata model with which to tag the information object. For example, consider a document containing the sentence “The countries of Scandinavia, which include Denmark, Norway, and Sweden, have long summer days and long winter nights.” From this document, the terms Scandinavia, Denmark, Norway, and Sweden may be extracted. Each of these terms is individually used to lookup matching metadata instances in the metadata model. The GUID of any identified metadata instances are recorded on the catalog item uniquely associated with this document.

### Synonym- and Language Variation-Based Classification

Metadata instances in the metadata model can include synonyms and language variations. The lookup of the metadata model includes comparing a term (e.g., content taken from the information object) with any synonyms and language variations associated with the metadata instance. For example, consider a metadata instance with a display name of Netherlands and defined synonyms that include Holland. Further, consider that term Holland is extracted from a document being classified. Lookup of the metadata model identifies the Netherlands metadata instance as a match because the extracted term Holland matches the associated synonym Holland. Consequently, the GUID of the Netherlands metadata instance is recorded on the catalog item associated with the document.

### Relation-Based Classification:

In general, relationship-based classification uses the links (i.e., relationships between metadata instances) of the metadata model 104 to identify metadata instances with which to tag an information object. For example, consider an information object being authored by Dan T. To classify the information object, the classification module identifies Dan T. as the author and finds a metadata instance for Dan T. in the metadata model. In addition, the metadata instance for Dan T. has two relations; one relation identifies the department (e.g., engineering) in which he works and the other relation identifies his role (e.g., chief scientist). These relations between the author, department, and role metadata categories are based on the relationships established from the enterprise database systems, as illustrated by the metadata category graph 106 (FIG. 6). On the catalog item for this information object the classification module stores the GUIDs of the metadata instances corresponding to the engineering department and chief scientist role. Advantageously, classifying information objects with relation-based tags causes terms that are not embodied in the content of the information object to become associated with the information object for searching purposes. To illustrate using the previous example, the information object authored by Dan T. may make no mention of the engineering department, yet now a submitted search that specifies the engineering department will discover this information object.

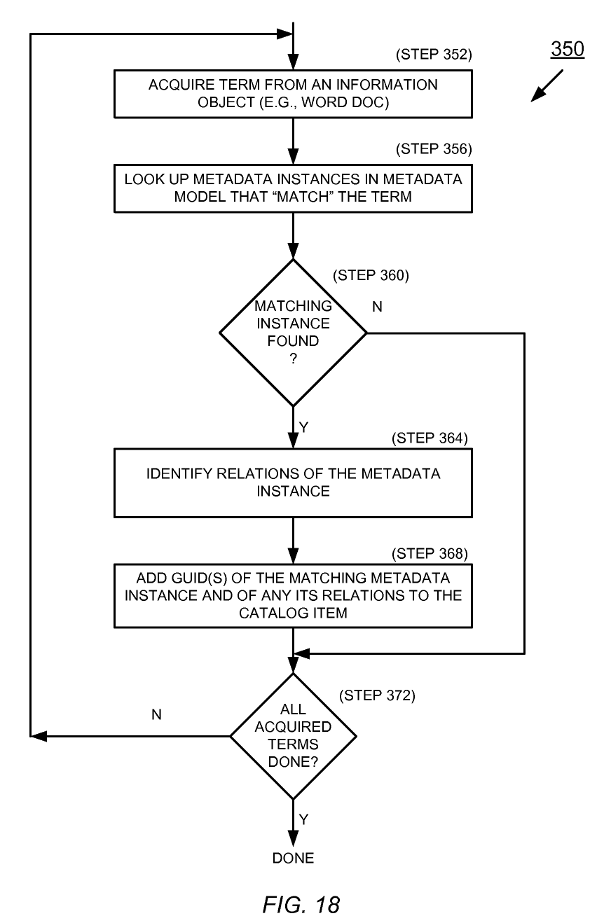

FIG. 18 shows an embodiment of a process 350 for generating metadata for an information object based on relations in the metadata model. At step 352, a property or a term is acquired from the information object. At step 356, the metadata instances in the metadata model are searched to find a match of the term (e.g., in the display name, in a synonym, in a relation, in a language variation). The criterion for finding a match can require an exact match or that the term appears in any part of another term or phrase in a metadata instance.

If a matching metadata instance is found (step 360), any relations of that metadata instance are considered. Each relation represents another metadata instance that can be used to tag the information object. The classification module 128 stores (step 368) each identified metadata instance to the catalog item uniquely associated with the information object. The identification of metadata instances continues (step 372) for each term or property acquired from the information object. When the process 350 completes, a considerable number (e.g., hundreds, thousands) of metadata instances may be stored on the catalog item for that information object, many of which represent terms that do not even appear in the body of the information object.

### Location-Based Classification

Many document management systems and file systems employ a hierarchical structure for storing and organizing information objects. The hierarchical structure can include named folders and subfolders within which the information objects are located. This hierarchical arrangement facilitates finding and accessing the information objects. In brief overview, location-based classification treats object locations, such as sites, areas, document libraries, file folders (e.g., Microsoft NTFS), and file subfolders, like information objects, creating catalog items for them and tagging them with metadata instances. The folder location of an information object then operates to identify additional metadata instances for tagging the information object (additional to its own); the information object inherits the metadata instances of any folder or subfolder within which the information object resides. Thus, location-based classification provides a capability lacking in or unsupportable by some data stores, such as file systems and document management systems; that is, the ability to associate metadata with object locations.

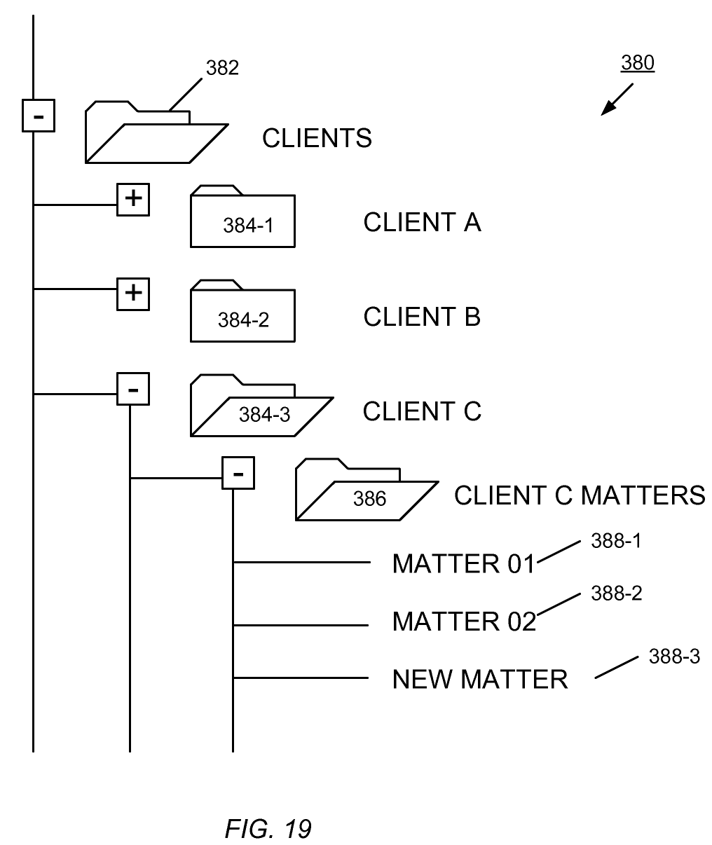

For example, consider a hierarchical structure 380 of a file system as shown in FIG. 19. The structure 380 includes a folder 382 named “Clients” at a first hierarchical level. The folder 382 includes three sub-folders 384-1, 384-2, and 384-3 named “Client A”, “Client B”, and “Client C”, respectively. The Client C sub-folder 384-3 contains a sub-folder 386 named “Client C Matters”. The Client C Matters sub-folder 386 has two files (i.e., information objects) 388-1, 388-2 named Matter 01 and Matter 02, respectively. In the catalog 108 (FIG. 4) is a catalog item for each folder 382 and subfolder 384, 386, each catalog item being tagged with various metadata instances. In addition to its own metadata instances, the catalog item for the information object 388-1 includes the metadata instances of the subfolders 384, 386 and of the folder 382. Similarly, the catalog item for subfolder 386 includes the metadata instances of subfolder 384 and folder 382.

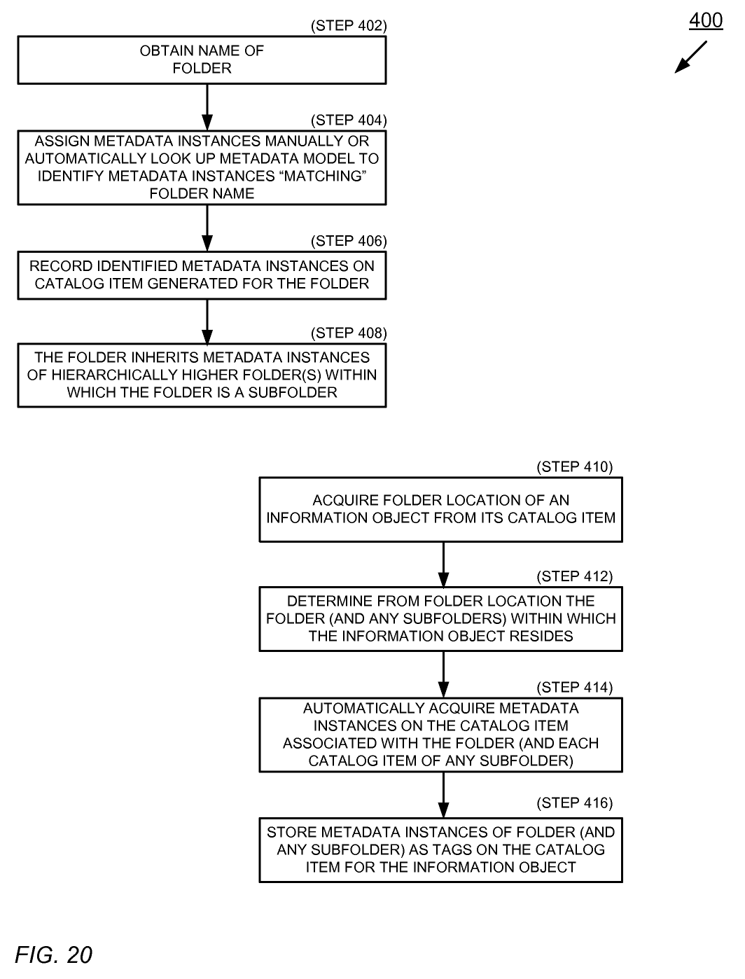

FIG. 20 shows an embodiment of a process 400 for generating metadata for a folder (site, or document library) and for an information object located in that folder. At step 402, the name of the folder is acquired from a data store (e.g., a file system, a SharePoint server). A lookup of the metadata model identifies (step 404) various metadata instances matching the folder name, number, abbreviation, etc. Identification of these metadata instances can be based on relations, content, synonyms, language variations, or combinations thereof. A user can also assign metadata instances manually to the folder. At step 406, the GUIDs of the identified metadata are recorded on a catalog item generated for the folder. If the folder is a subfolder, the catalog item for the folder inherits (step 408) the metadata instances from each folder and subfolder in the hierarchical file structure within which the folder resides.

As part of the process of generating metadata instances for an information object, the folder location of the information object is acquired (step 410) from the catalog item of that information object. Determined from this folder location are the folder (and any of its subfolders) within which the information object resides (step 412). The metadata instances recorded on the catalog item corresponding to this folder (and each catalog item of any of its subfolder) are acquired automatically (step 414) and stored (step 416) as tags (i.e., GUIDs of metadata instances) on the catalog item for the information object.

### User-Access Right Based Classification

One of the user-access rights that can be assigned to each metadata instance, the tagging right, controls whether the metadata instance can be suggested to a user for classifying an information object. In effect, the tagging right personalizes the metadata model for each particular user: a first user has a first subset of metadata instances available for tagging information objects, whereas a second user has a different subset of available metadata instances.

### Personalized Tagging

The tagging right enables personalized tagging. Personalized tagging improves the accuracy of information object classifications by limiting the metadata instances suggested to the client user during semi-automatic tagging to those for which the user has been granted a tagging right. Although the classification module could identify some metadata instances as relevant to the information object being classified, if the user does not have a tagging right for those metadata instances, the classification module does not display them. The tagging right also controls which metadata instances appear to a user who searches or browses the metadata model for manual tagging.

### Searching

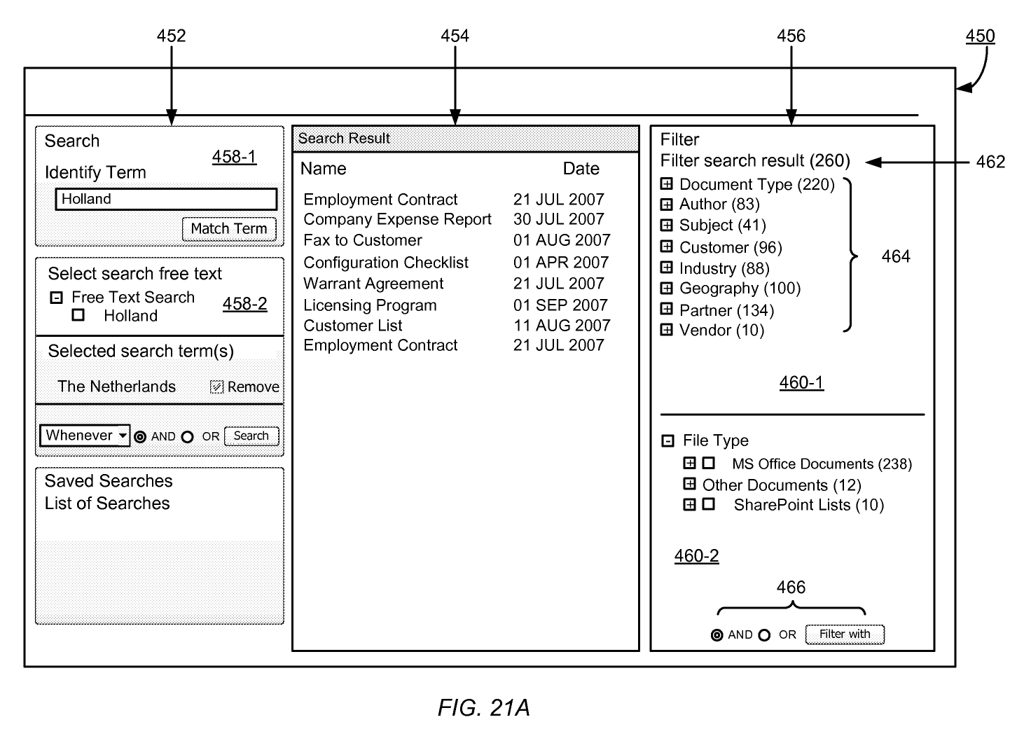

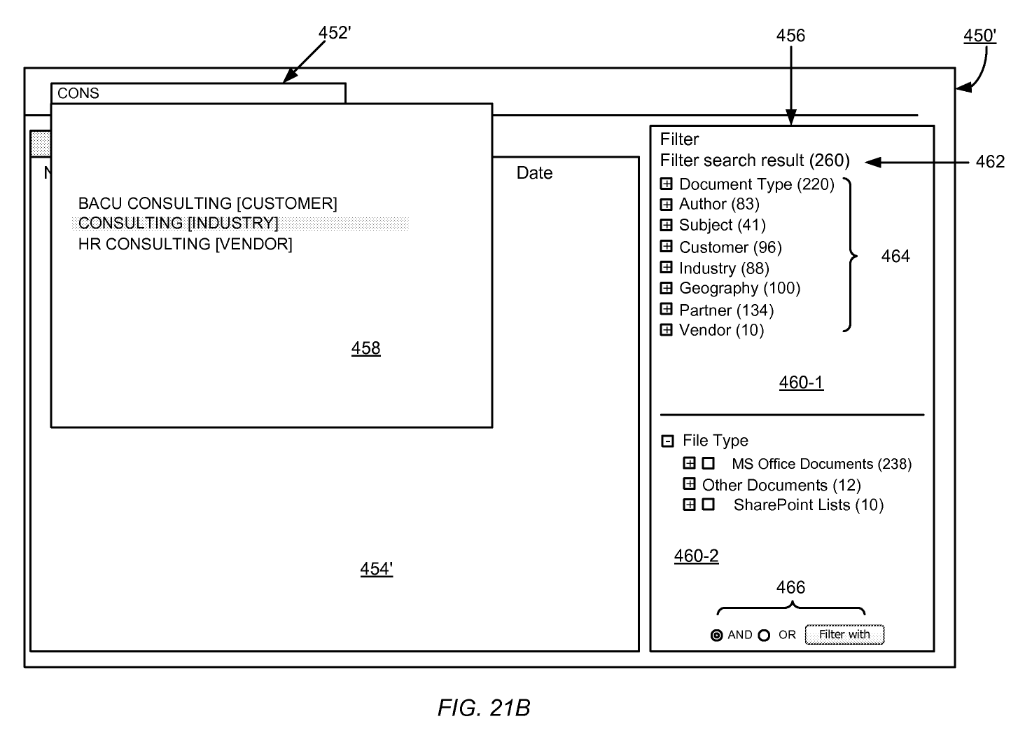

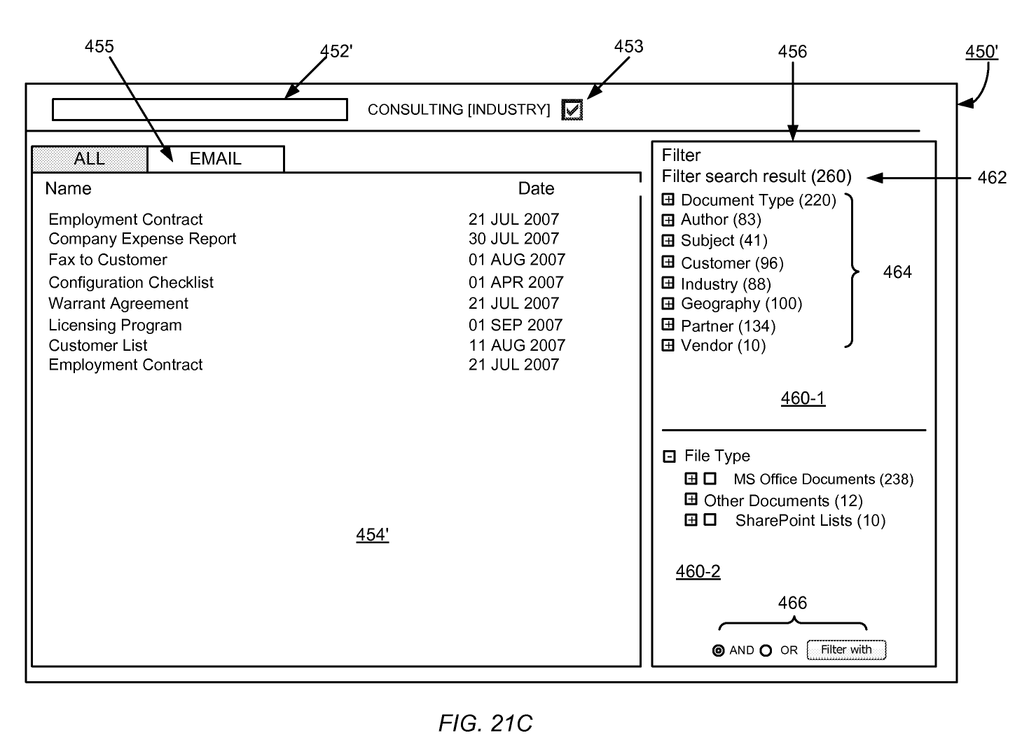

FIG. 21A shows an example of graphical user interface 450, produced by the search module, through which a user can submit a search query. The user interface includes three panes: a left pane 452 for receiving a user-supplied text string; a middle pane 454 for displaying a list of information objects found after an initial search of the index and any post-search filtering; and a right pane 456 for post-search filtering of the information objects listed in the middle pane 454.

More specifically, the left pane 452 includes a first section 458-1 with an input box for receiving the user-supplied text string (here, e.g., Holland). The user can check a box to perform an exact match of the text string. If left unchecked, the lookup of the metadata model looks for metadata instances satisfying any part of the text string. A second section 458-2 of the left pane 452 gives an option to the user to perform a free-text search of the index using the supplied text string.

The middle pane 454 lists the names and dates of each information object found in the search of the index. Each displayed name is an active link for accessing the associated information object in its particular data store (i.e., activation launches the particular third-party application for viewing, among other things, the information object). The list of information objects may be sorted, for example, by date, by name, or by file type.

The right pane 456 has a first section 460-1 in which is displayed the “filtered search result” 462 and the number of information objects displayed in the middle pane 454. Also displayed are the various metadata categories 464 into which the listed information objects fall. Adjacent each displayed metadata category is a parenthesized number representing the number of listed information objects that fall under that metadata category.

In a second section 460-2 of the right pane 456 is a breakdown of the different file types for the listed information objects. Also in this section 460-2 are control buttons 466 for filtering the listed information objects, as described further below.

FIG. 21B shows another example of graphical user interface 450′, produced by the search module, through which a user can submit a search query. The user interface 450′ includes an input box 452′ for receiving the user-supplied text string and a two panes: a left pane 454′ for displaying a list of information objects (and locations) found after an initial search of the index and any post-search filtering; and a right pane 456 for post-search filtering of the information objects listed in the left pane 454′. The right pane 456 is the same as that shown in the graphical user interface 450 of FIG. 21A.

A drop-down box 458 partially obscures the left pane 454′. The drop-down box 458 opens to present personalized type-ahead suggestions, if any, to the user based on the text string currently in the input box 452′. In the example shown, the search module has found three “matching” metadata instances in the metadata model for the incomplete text string “CONS” and presented them as type-ahead suggestions. In this example, the user has selected (i.e., highlighted) the type-ahead suggestion called Consulting [Industry], the bracketed term corresponding to the metadata category of the metadata instance.

FIG. 21C shows the user interface 450′ after the user chooses the Consulting [Industry]. The left pane 454′ shows all found information objects. The search term appears adjacent to the input box 452′. The check box 453 indicates that this search term was used to find the listed information objects. By selecting the “EMAIL” tab 455, the user can cause the user interface 450′ to present only those information objects that are email messages.

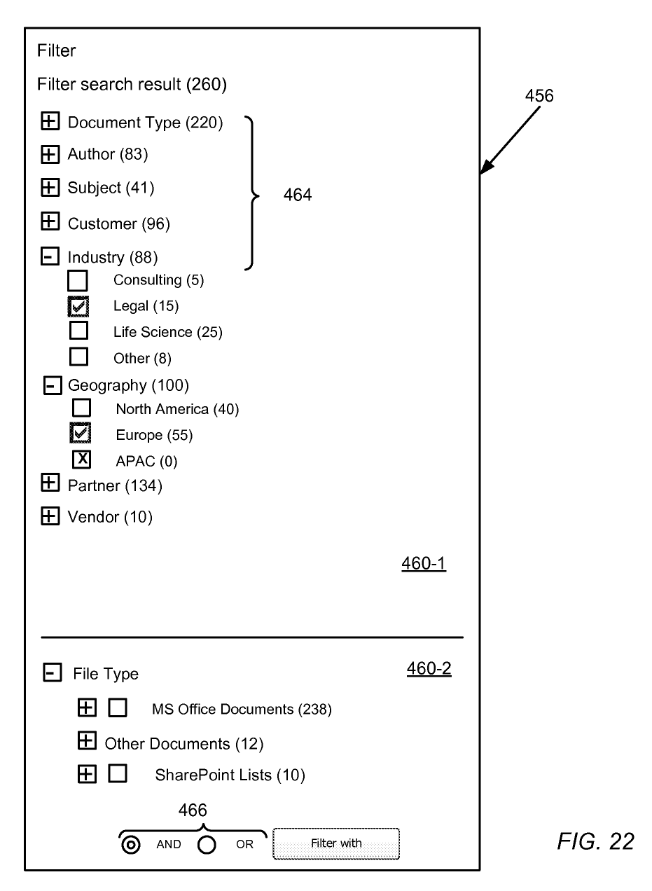

FIG. 22 shows the right pane 456 (of either user interface 450, 450′) with some of the metadata categories 464 expanded (in particular, the Industry and Geography categories) to show the various metadata instances that fall under these metadata categories. For example, under the Geography category are the North America, Europe, and APAC metadata instances. Each of these metadata instances can further expand to show other metadata instances. For example, The Netherlands can appear under the Europe metadata instance. In addition, each of the displayed metadata categories and instances are personalized to the user; that is, only those metadata categories and instances for which the user has been granted a viewing right appear in the right pane 456.

Adjacent each of the displayed metadata instances is a parenthesized number representing the number of information objects listed in the middle pane 454, 454′ that are related to the metadata instance. For example, here, 25 of the 260 listed information objects have some relationship to Life Sciences directly, via relations, or via inherent tags.

Also adjacent each displayed metadata instance is a check box. If the user wants to exclude information objects of a particular subject matter from the results, an X is entered in the adjacent check box. Here, for example, APAC is excluded from the search results, resulting in (0) information objects for that metadata instance. Entering a check in an adjacent check box selects that particular subject matter. Here, for example, the user is interested in seeing the list of information objects related to Legal and Europe. Any combination of the metadata instances under any of the metadata categories may be specifically selected, specifically excluded, or left unselected for purposes of filtering the search results. In addition, the control buttons 464 determine whether an AND operation or an OR operation is performed on the selected metadata instances.

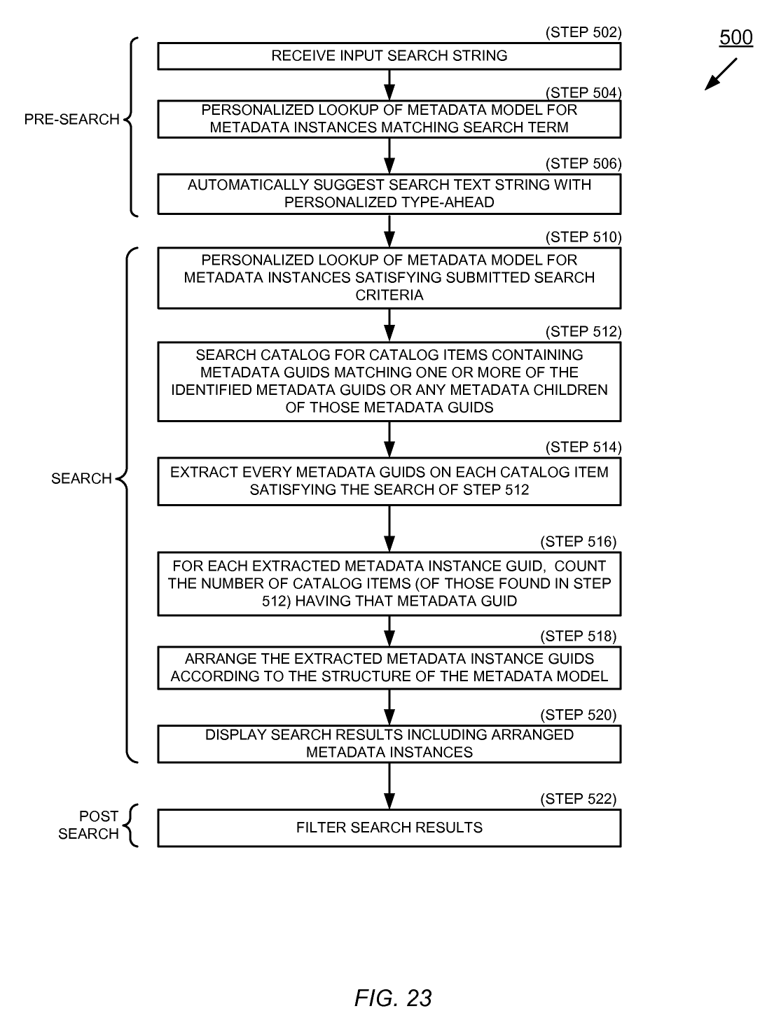

FIG. 23 shows an embodiment of a search process 500 conducted in accordance with the principles of the invention. In the description of the process, reference is made also to FIG. 22. The search process 500 can be considered to occur in phases: (1) pre-search; (2) search; and (3) post-search. During pre-search, the searching module receives (step 502) a user-supplied text string. As the user types the text string into the box provided in the left pane 452, the searching module looks up (step 504) the metadata model for metadata instances that match or contain the text string (as it presently appears). The lookup of the metadata model compares the user-supplied text string with the display names, any synonyms, and any language variations of each metadata instance and language variance. This lookup is personalized to the user entering the text string: only those metadata instances for which the user has a viewing right are eligible for matching the text string.

If a “matching” metadata instance is identified, the searching module can suggest (step 506) this metadata instance as a search text string by typing the matching term ahead in the search term box in the left pane 452 (for user interface 450) or in the drop-down box 458 (for user interface 450′).

In one embodiment of the searching module, illustrated in dashed lines, used in conjunction with the user interface 450, the searching module may also suggest (step 508) other terms to the user that may be incorporated into the search based on metadata instances identified during this lookup. These terms appear in the section 458-2 of the left pane 452 of the user interface 450. The user can elect to keep or remove any suggested term. The user can also establish search criterion to be applied to the search terms by selecting either an AND operation or an OR operation.

When the user proceeds with the search (e.g., by accepting a type-ahead suggestion or completing entry of the text string) the lookup of the metadata model identifies (step 510) one or more matching metadata instances and metadata children of those matching metadata instances. Again, the lookup of the metadata model is personalized to the user—only those metadata instances for which the user has a viewing right are eligible for selection. If the text string includes more than one term, the lookup identifies metadata instances in accordance with the submitted search criteria: that is, satisfying any one of the terms for an OR operation or satisfying every term for an AND operation.

Each metadata instance identified in the lookup has a GUID. At step 512, the catalog is searched for catalog items with any one of these GUIDs, including GUIDs of the metadata children of the matching metadata instances, recorded thereon. If the user has selected a free-text search, the search of the catalog includes searching for catalog items with document content that satisfies the search criteria. Each catalog item found with a matching GUID or, in the event of a free-text search, with matching content becomes part of a second lookup of the metadata model.

Usually, many of the catalog items found in the search have multiple metadata GUIDs pointing to other metadata instances in the metadata model. The search module extracts (step 514) every metadata instance pointer (i.e., GUID) from each found catalog item (i.e., satisfying the search of step 512). At step 516, for each extracted metadata instance GUID, the search module counts the number of catalog items (of those found in step 512) having that GUID. At step 518, the metadata instances are arranged according to the structure of the metadata model—the search module uses each extracted GUID to find the corresponding metadata instance in the metadata model and to identify the metadata category within which that metadata instance falls.

The search module displays (step 520) the names of the information objects associated with the catalog items found during the search in the middle pane 454, 454′ and the total number of information objects found during the search in the right pane 456. No information object is displayed or counted for which the security settings on the associated catalog item indicate the user is unauthorized to access the information object. Thus, a situation may occur in which the information object is not listed in the middle pane 454, 454′ or counted among the filtered search results in the right pane 456, although its associated catalog item matches a metadata instance identified during the lookup of the metadata model.

Also displayed in the right pane 456 are the various metadata categories and metadata instances to which map the catalog items found during the search. The number appearing adjacent each displayed metadata category represents the number of catalog items, and thus the number of information objects, that fall under that metadata category. Displayed under each metadata category are the metadata instances that fall under each category. The metadata instances may not yet be visible in the right pane 456 if the tree representation of the search results is collapsed. The number appearing adjacent each metadata instance corresponds to the number of catalog items with a GUID pointing to that metadata instance. Every found catalog item is accounted for in this displayed list of metadata categories and instances.

After the initial search (i.e., during the post-search phase), the user can filter (step 522) the initial search results by selecting certain metadata instances appearing in the right pane 456 for exclusion, for AND'ing, or for OR'ing. This filtering is applied to every catalog item found in the search, across all displayed metadata categories. As a result of the filtering, the search module dynamically updates the list of information objects in the middle pane 454, 454′ and dynamically recalculates the number of information objects now falling under each metadata category and instance.

### Personalized Search Results

The filtered search results displayed to a user are personal to that user. Because of the viewing right assigned to each metadata instance in the metadata model, two different users submitting the same text string in a search query will receive two different search results: one user may have a viewing right for certain metadata instances to which the other user does not, and vice versa. Moreover, the security settings for the information objects may allow one user and not the other to access certain information objects.

### Free-Text Searching

The index with its metadata model and catalog can enhance free-text searching without performing an initial lookup in the metadata model. After the user submits one or more search terms, the document content of each catalog item in the catalog are searched for matches to those terms. For each catalog item with matching content, the metadata instance pointers (i.e., GUIDs) are extracted and used to identify metadata categories and instances in the metadata model. These identified metadata categories and instances are then displayed in the right pane 456 of the user interface, enabling the user to subsequently filter the search results as described above. The index of the present invention can be integrated with other database systems, such as MOSS and web search engines, to improve the filtering aspect of their free-text searching process.

### System Adaptability

In an enterprise, changes occur often to the data and structures of the enterprise database systems and to the information objects managed by the various data stores. To capture changes in the enterprise database systems, the connectors 140 (FIG. 5) of the model builder module remain in communication with and synchronized to the various enterprise database systems. From the enterprise database systems, the connectors 140 obtain updates and dynamically modify the metadata instances of the metadata model accordingly.

The information management system of the present invention adapts immediately to changes in the metadata model, irrespective of whether such changes are generated automatically or manually. For example, consider a user who manually changes the display name of a metadata instance from “Holland” to the “van Gogh's Birthplace”, provided the user has a user-access right to modify this metadata instance. As soon as the user saves this change to the metadata model, the new display name is immediately available for subsequent searches. In addition, changes do not need to be made to catalog items in the catalog. Any catalog item linked to the Holland metadata instance before the name change remains linked to the same metadata instance after the name change because the GUID of the metadata instance has not changed—and the catalog items use this GUID to link to the metadata instance.

As another example, consider a user who “drags and drops” a metadata instance from one location in the tree structure of the metadata model to another location. For example, assume the user moves the Holland metadata instance from beneath the Europe metadata instance so that it now branches from a metadata instance called Scandinavia. Again, as soon as the user saves this change, this new tree structure is immediately effective. Again, any catalog item linked to the Holland metadata instance before the change remains linked to the same metadata instance after the change. Because of the change, if a catalog item pointing to the Holland metadata instance becomes counted in a filtered search result, the count appears in the list of filtered search results under Scandinavia, rather than under Europe.

If a user manually adds and saves a new metadata instance to the metadata model, the new metadata instance is available immediately for lookups and for appearing in the list of filter search results. When a metadata instance is deleted from the metadata model, the details of the deleted metadata model are unavailable for lookups and filtering as soon as the changed metadata model is saved. Scheduled periodic scans of the catalog parse each catalog item to find and remove GUIDs of metadata instances that have been deleted.

The information management system also dynamically adapts to changes affecting information objects. For example, consider an information object that is removed from a document management system (with native metadata) and added to a file system. In prior art systems, the act of removing the information object from the document management system may sever ties with the native metadata, causing the native metadata to be lost. Because the present invention fingerprints each information object with a globally unique DOC ID (or LOC ID), the catalog item uniquely associated with the information object, previously managed by the document management system, continues to point to the information object, now managed by the file system. In addition, the catalog item continues to store the native metadata that the document management system previously associated with the information object; i.e., the transfer of the information object from one data store to another has not lost the native metadata.

Software of the present invention may be embodied as computer-executable instructions in or on one or more articles of manufacture, a computer program product, or in or on computer-readable medium. Examples of such articles of manufacture and computer-readable medium include, but are not limited to, any one or combination of a floppy disk, a hard disk, hard-disk drive, a CD-ROM, a DVD-ROM, a flash memory card, a USB flash drive, an EEPROM, an EPROM, a PROM, a RAM, a ROM, or a magnetic tape.

A computer, computing system, or computer system, as used herein, is any programmable machine or device that inputs, processes, and outputs instructions, commands, or data. In general, any standard or proprietary, programming or interpretive language can be used to produce the computer-executable instructions. Examples of such languages include PHP, Perl, Ruby, C, C++, C#, Pascal, JAVA, BASIC, and Visual C++. The computer-executable instructions may be stored on or in one or more articles of manufacture, or in or on computer-readable medium, as source code, object code, interpretive code, or executable code. Further, although described generally as software, embodiments of the described invention may be implemented in hardware, software, or a combination thereof.

Although the invention has been shown and described with reference to specific preferred embodiments, it should be understood by those skilled in the art that various changes in form and detail may be made therein without departing from the spirit and scope of the invention as defined by the following claims.

What is claimed is:

1. A method of performing an electronic search for information objects stored in a plurality of data stores, the method comprising:
identifying a user submitting a text string;
providing a metadata model comprising a plurality of interconnected nodes, at least one of the nodes corresponding to a metadata instance and at least one of the nodes corresponding to a metadata category;
providing a catalog of catalog items, each catalog item being linked to one or more metadata instances in the metadata model and uniquely associated with an information object in one of the data stores;
assigning a user-access right to each metadata instance and to each metadata category;
searching the catalog to find one or more catalog items that are linked to one or more metadata instances in the metadata model that satisfy the user access right and criteria associated with the submitted text string;
extracting, in real time, all links to metadata instances from each of the catalog items found in the search of the catalog; and
displaying each metadata instance corresponding to one of the extracted links, if so permitted for the identified user by the user-access right assigned to that metadata instance.

2. The method of claim 1, further comprising the step of displaying each information object associated with a catalog item found in the search of the catalog.

3. The method of claim 2, further comprising the step of assigning a security setting to each catalog item to determine who is authorized to access the information object associated with that catalog item.

4. The method of claim 3, further comprising the step of obtaining the security setting of each catalog item from the data store maintaining the information object associated with that catalog item.

5. The method of claim 3, further comprising the steps of:
determining, for each catalog item found in the search of the catalog, whether the identified user is unauthorized to access the information object associated with that catalog item based on the security setting assigned to that catalog item; and
excluding from display each information object for which the identified user is determined to be unauthorized to access.

6. The method of claim 3, further comprising the steps of counting for each metadata instance a number of found catalog items linked to that metadata instance; and
excluding from the counting each catalog item determined to be associated with an information object for which the identified user is unauthorized to access.

7. The method of claim 1, further comprising the step of looking up, in the metadata model, metadata instances that satisfy criteria associated with the submitted text string and the user-access right assigned to each instance of metadata based on the identity of the user.

8. The method of claim 7, further comprising the step of suggesting, in real time, one or more type-ahead text strings to the user while the user is entering the text string, each suggested type-ahead text string being based on one of the metadata instances found during the look-up of the metadata model.

9. A system for performing an electronic search for information objects stored in a plurality of data stores, the system comprising:
a metadata model having a plurality of interconnected nodes, at least one of the nodes representing a metadata instance and at least one of the nodes representing a metadata category, a user-access right being assigned to each metadata instance and to each metadata category;
a catalog of catalog items, each catalog item being uniquely associated with an information object stored in one of the data stores, each catalog item being linked to one or more of the metadata instances of the metadata model;
a search module identifying a user who submitted a text string, searching the catalog to find one or more catalog items that are linked to one or more metadata instances in the metadata model that satisfy the user access right and criteria associated with the submitted text string, and extracting in real time all links to metadata instances from each of the catalog items found in the search of the catalog; and
means for displaying each metadata instance corresponding to one of the extracted links, if so permitted for the identified user by the user-access right assigned to that metadata instance.

10. The system of claim 9, wherein the means for displaying displays each information object associated with a catalog item found in the search of the catalog.

11. The system of claim 10, further comprising a classification module assigning a security setting to each catalog item to determine who is authorized to access the information object associated with that catalog item.

12. The system of claim 11, wherein the classification module obtains the security setting of each catalog item from the data store maintaining the information object associated with that catalog item.

13. The system of claim 11, wherein the search module determines, for each catalog item found in the search of the catalog, whether the identified user is unauthorized to access the information object associated with that catalog item based on the security setting assigned to that catalog item, and excludes from display each information object for which the identified user is determined to be unauthorized to access.

14. The system of claim 11, wherein the search module counts, for each metadata instance, a number of found catalog items linked to that metadata instance, and excludes from counting each catalog item determined to be associated with an information object for which the identified user is unauthorized to access.

15. The system of claim 9, wherein the search module looks up, in the metadata model, metadata instances that satisfy criteria associated with the submitted text string and the user-access right assigned to each instance of metadata based on the identity of the user.

16. The system of claim 15, wherein the search module suggests, in real time, one or more type-ahead text strings to the user while the user is entering the text string, each suggested type-ahead text string being based on one of the metadata instances found during the look-up of the metadata model.
